(19) United States
(12) Patent Application Publication
(10) Pub. No.: US 2026/0327992 A1
(43) Pub. Date: Oct. 22, 2026

(54) CONSTRUCTION OF INSULATED WALLS BY WET CLADDING

(71) Applicant: TIDHAR ECO WALL LTD, Ramat HaSharon (IL)

(72) Inventors: Moshe LAMDAN, Kadima Tzoran (IL); Ariel POKOTINSKY, Ramat HaSharon (IL)

(73) Assignee: TIDHAR ECO WALL LTD, Ramat HaSharon (IL)

(21) Appl. No.: 19/106,680

(22) PCT Filed: May 17, 2022
(86) PCT No.: PCT/IL2022/050512

§ 371 Date: Feb. 26, 2025

(51) Int. Cl. E04F 13/08

(52) U.S. Cl. CPC E04F 13/0846; E04F 13/0885

(57) ABSTRACT

Methods of constructing cladded structures are disclosed. The cladding elements are lined with insulating elements such that a back surface of the end cladding elements and a front surface of the insulating elements form intimate contact there between. Structures generated thereby are also disclosed.

### RELATED APPLICATIONS

The instant application claim priority under the Paris Convention from Israel Application No. 288212, filed 17 Nov. 2021, the contents of which is hereby incorporated by reference in its entirety.

### FIELD AND BACKGROUND OF THE INVENTION

The present invention, in some embodiments thereof, relates to methods of constructing insulated walls by wet cladding, kits and systems capable of same and insulated, structures cladded therewith.

Wall cladding is often used in place of plastering to provide an aesthetic and durable finish to both interior and exterior walls. The finish may be decorative as well as functional. There are different wall cladding systems and methods. Gluing is the simplest and cheapest method, and is often used for internal walls. In this method an end cladding element or material (as these terms are used alternatively throughout), e.g., a ceramic tile, is directly glued onto an existing (i.e., pre-existing, backup, all three terms are used herein interchangeable) wall. Building standards typically limit the use of gluing for external wall cladding at least to maximal height and/or weight or tile size, as gluing durability relies on the skill of the workman, material selection and aging and is therefore difficult to ensure.

Dry wall cladding is a system used primarily on external walls. In dry wall cladding, the end cladding material is mechanically fixed directly or indirectly to a (pre-existing) wall with steel attachments, e.g., screws, that restrain its vertical and horizontal movement. The steel attachments may be fixed directly into the wall, or may be fixed onto galvanized or stainless metal beams positioned along and connected to the pre-existing wall. Various types of attachments are available. In one known method, an attachment in the form of an undercut anchor which is secured to the back surface (i.e., underside) of the end cladding material is used. This method is based on drilling an undercut hole into the back surface of the end cladding material and fixing the undercut anchor onto the end cladding material with a simple screw aimed at flaring the undercut anchor. Typically, the end cladding material is fixed to the wall with an air gap formed by the beams. The air gap may provide ventilation as assisting in thermal insulation of the cladded structure. Although dry wall cladding is known to be highly durable, it is also costly and requires skilled labor as compared to the gluing method and/or wet cladding methods as is further delineated herein below. Because of the large potential number of locations in the back surface of the end cladding element, in dry cladding there is no size limitation imposed by the method per se to the size of the end cladding element. This allows for architectural and functional variations as required and/or desired. Hence, dry cladding allows the architectural selection of numerous end cladding materials, such as, but not limited to, ceramics, stone, artificial stone, architectural concrete, HPL and various forms of aluminum in any size, shape, color, texture, shin or finish.

Wet cladding is another method for external wall cladding that is often used in Israel, as well as other regions in the middle-east to clad external walls with natural stone and/or artificial stone made of concrete (for the latter, see section 1872 Part 1 of the Israeli building standard). About 80% of the residential buildings in Israel are cladded using wet cladding methodologies. Wet cladding involves embedding mechanical fixing elements into an end cladding element at one end and to a wet cementitious material at the other end.

For both regulatory and practical reasons, all three wet cladding methods practiced in Israel are limited to stone.

One method of wet cladding which is limited to stone having 2-3 cm thickness, is detailed in section 2378 Part 2 of the Israeli building standard and is typically used when cladding with Jerusalem stone. Section 2378 Part 2 requires fixing a reinforcement metal mesh to a backup wall, gluing a row of stones over the reinforcement metal mesh with mortar while mechanically fixing the stones to the reinforcement metal mesh and the mortar (once hardened) that with metal pins having a predefined structure. Each such metal pin has a proximal section, a middle section and a distal section. The proximal section of the pin is designed to be inserted into a pre-drilled hole extending along the thickness, i.e., the edge surface, the upper, left and right side, of the stone, which is why the stone has to be at least 2 cm thick. This is true for all of wet cladding methods practiced. The distal section is designed to protrude out of the edge surface of the stone towards the net and backup wall. Section 2378 Part 2 further requires forming a slot extending from the hole to the back surface of the end cladding material, so as to embrace the middle section of the pin, in order to ensure the pin will not fall off the stone during construction. The metal pins provide for mechanical fixing to secure the stones to the backup wall in addition to gluing, i.e., chemically bonding, with the mortar, resulting in higher durability and safety of the cladded structure. As discussed, in Section 2378 Part 2, the end cladding material is required to be stone having a thickness of at least 2 cm. The metal pins are required to have a diameter of 3.5 mm. The 2 cm thickness supports drilling holes and slots through a thickness (i.e., side) of the stone and accommodates inserting the metal pins with a diameter of 3.5 mm therein. This particular cladding method requires assembling a scaffold for constructing a backup wall, disassembling the scaffold and allowing the backup wall to harden, re-assembling the scaffold for cladding and re-disassembling the scaffold after cladding. Thus, scaffolds are assembled and disassembled twice. This process is labor intensive, far from being “industrial”, not at all economical and/or regulatory viable and not at all practical for buildings higher than 9 stories.

The Baranovich method (named after Eng. Mr. Baranovich, who invented the method) is yet another known wet cladding method that has been commonly used in Israel since the 1980's. The Baranovich method is designed to solve the limitations described above for wet cladding, rendering wet cladding more industrial, less labor-intensive, cheaper, faster to construct and practical for buildings of any height. In fact, nearly all residential building higher than 9 stories in Israel are built using the Baranovich method. The Baranovich method is solely practiced in Israel. Standardization of this method was established in 2015 in the Israeli Building standard 2378 Part 5. In the Baranovich method, the external wall of a structure is formed and concurrently cladded with a stone exterior. Being more industrialized, this method conserves construction time, is less prone to construction mistakes and increases the durability and homogeneity of the cladding. In the Baranovich method, rows of stones are laid against an outer formwork sheet and similar to the manual wet cladding method described above, metal pins are fitted through pre-drilled holes and slots. A reinforcement metal mesh is placed behind the stones with the pins extending in the direction of the reinforcement metal mesh, without a required physical engagement there between. The stones are held in place by tying the reinforcement metal mesh and the outer formwork sheet with a barbed wire which is inserted via holes formed in the outer formwork sheet, thereby securing the stones between the outer sheet and the reinforcement metal mesh. Rows of stones are spaced from one another via spacers formed on the back surface of the outer formwork sheet. The gaps between the stones are sealed with a cementitious material commonly referred to in the art as “chochla” and the back surface is covered with a sealant, e.g., a primer, to prevent soaking of cement into the volume of stone, thereby preventing irreversible staining of the front surface of the stone. At this stage, a plurality of the described assemblies are hoisted (i.e., lifted) with a crane to a floor under construction, the inner formwork sheets are put in place (with or without heat insulating building blocks placed between the inner formwork sheet and the reinforcement metal mesh) and tied to the respective outer formwork sheets via a plurality of securing bolts passing between the two sheets through dedicated holes, generating a continuous formwork circumferencing the floor under construction. Concrete is poured in the gap between the inner formwork sheets (or the heat insulating building blocks when used) and the end cladding stone rows, in which gap the reinforcement metal mesh is pre-positioned. Once the concrete hardens the ties, the securing bolts and both formwork sheets are removed. The reinforcement metal mesh together with the concrete forms the external wall of the structure and cladding can then be carried out in a single step, without the need for scaffolds altogether. Building standard 2378 Part 5 also requires stone having a thickness of at least 2 cm and pins having a diameter of 3.5 mm. In practice, this standard also applies to pre-cast cladded walls, the difference being that the walls are typically formed in a factory and thereafter brought to a construction site and hoisted to floors under construction. Pre-cast stone cladded walls can be formed horizontally as well, whereby stone with pins as herein described are placed horizontally with the pins extending upwardly. A reinforcement metal mesh is placed thereon and concrete is poured to form the cladded pre-cast wall. Similarly, pre-cast stone cladded walls can be formed horizontally by forming a fortified wall structure (having a reinforcement metal mesh buried therein) and prior to hardening of the concrete, placing thereon end cladding stones with pins as herein described, the pins extending downwardly into the concrete and are physically engaged thereby when the concrete hardens.

For traditional wet cladding method and the Baranovich method, the mechanical fixing requires inserting pins through pre-drilled holes formed in the thickness (sides) of the stones. The stone for this purpose is required to have a certain thickness to support the drill hole and the pins.

The Baranovich method has its specific limitations as well. One major limitation is the fact that liquid cement pours through the gaps formed between the stones in the regions of the pins and in locations where the “chochla” seal is compromised, as well as through the holes formed in the outer formwork sheet for insertion of the barbed wire, and more so through the bolts dedicated holes, resulting in cementitious material accumulating between the front surface of the stones and the back surface of the front sheet, staining the façade of the cladded wall. Such stains have to be removed after the entire construction is completed using sanding disk and/or pressurized water (see, for example, FIG. 15). This cleaning process costs ca. 40% of the total cost of typical cladding.

Another limitation associated with the Baranovich method is the misplacement of the pins, which are loosely engaged by the drilled holes, resulting in weakening the mechanical fixing of the stone to the concrete wall. Due to potential misplacement of the pins, while constructing using the Baranovich methods, the use of concrete pumps and ultrasonic vibrators are forbidden, hampering the construction quality as a whole.

The cladding regulations and methods described herein are limited to stone, which is thick for reasons described above and is therefore heavy, requiring heavier fortification for the entire structure.

Also, stone has inherent limitations, as detailed below:

It has a very high water absorption, requiring the addition of heat insulation layers to the inner side of the external walls of the structure and resulting in high water ingress and accelerated ageing of the construction as a whole.

It ages non-homogenously, its aging behavior is variable and unpredictable, resulting in cladding failure.

It readily stains, e.g., by graffiti, as it soaks the stains.

It is costly for numerous reasons. First natural stone is inherently costly. Second, natural stone is heavy, resulting is high shipping costs.

The architectural variety of cladding material is very limited to the extent that all the facades of constructions built therewith in Israel look very similar. The color consistency of natural stone is very poor.

The regulation requires that the pins are to be spaced no more than 30 cm apart from one another, resulting in that all the buildings wet cladded with stone are made of 30 cm high stone stripes because, as described above, the mechanical fixing pins are engaging the stone through the thickness (side) thereof.

Last, but not least, the use of natural stone harms the environment, considered not “green” and therefore quarries are being discontinued worldwide.

Table 1 below summarizes some of the differences between stone and non-stone (e.g., porcelain) end cladding elements.

TABLE 1

| | 10 mm thick | 20 mm thick |
|---|---|---|
| Item | Porcelain Tile | Natural Stone |
| Thermal Conductivity | 3 times more | — |
| | insulating | |
| Water Sealed Façade | + | — |
| Bending Strength (MPa) | 38 | 17 |
| Breaking Strength | At least 2500 | 1600 |
| Scratch Resistance | + | — |
| Chemical Resistance | + | — |
| Doesn't Contain salable salts and | + | — |
| Minerals | | |
| Consistent strength and resistance | + | — |
| Low Expansion with temp change | + | — |
| Uniform Size and color | + | — |
| Wide architectural variety | + | — |
| Doesn't Requires Expensive cleaning | + | — |
| Does not Absorb water and concrete | + | — |

Patent number IL243159 describes a cladding method designed to assist in thermal insulation by forming an air gap and ventilation path for hot air through the gap. The gap is formed by spacing a thermal insulation layer from the end cladding elements via spacers and pouring concrete between the back side of the layer and a back sheet of a formwork. Heat insulation layers are formed from soft, air trapping, materials, otherwise they are dysfunctional as heat insulating elements.

The drawbacks of the cladding method described in IL243159 are numerous.

First, during pouring of concrete at 600 Kg per square meter (as is the case using conventional Baranovich formwork), the heat insulation layer, especially at the lower end of the formwork, albeit the spacers, is likely to collapse over the back surface of the cladding elements, thereby eliminating or constricting the air gap, resulting in compromised or no air ventilation.

Second, the holes formed in the heat insulation layer to allow pins to protrude from the back surface of the layer into the concrete will allow the wet concrete to spill into the gap, further eliminating or constricting the air gap, resulting in compromised or no ventilation.

Third, in order for the air gap to function as a ventilation gap, air gaps should also be maintained between the end cladding elements, resulting is a structure that may age faster over time due to water ingress through the gaps between the end cladding elements.

Fourth, although heat insulation layers are typically supplemented with fire retardants, nearly no fire retardation technology can prevent the ignition and burning of the insulation layer when fed by more and more heated oxygen containing air rushing ever faster through the gaps venting out from the top of the cladded structure, which may result in complete burnout and destruction of the entire cladded structure.

Fifth, there is no existing heat insulation layer that can withstand exposure to the elements over time as in this case. Indeed, ventilated building facades do exist, but are never used alongside with heat insulation layers exposed to the elements.

Sixth, the method described in IL243159, also does not allow the use of concrete pumps, nor the use of sonication probes, because the weight of the wet concrete and aggregates therein, especially when accelerated by the concrete pump or sonication probe is not dissipated by any means which may result in the disengagement of the pins from the pre-formed holes in the back side of the end cladding elements, especially if ceramic porcelain tiles are used, whereby the depth of the pre-formed undercut hole cannot extend beyond ca. 5 mm into the end cladding element.

Last, but not least, the cladding method described in IL243159 fails to comply with Israeli building standard 1555, section 4, that pertains to structures having external air ventilated facades. In fact, there is no standard or combination of standards that would allow constructing an external cladded wall using the method described in IL243159.

Additional background art includes JP2003328532; DE102007060956; and U.S. Pat. No. 5,083,407; as well as the Israeli standards for building coverings, including, e.g., standard 314—Ceramic tiles definitions and specifications; standard 1555 Part 1—flooring and cladding in porcelain and mosaic outdoor cladding; standard 1555 part 2—flooring and cladding in porcelain and mosaic indoor and closed; standard 1555 part 4—flooring and cladding in porcelain and mosaic dry cladding; standard 1872 part 1—Cladding in artificial stone—definitions; standard 1872 part 2—Cladding in artificial stone—wet cladding; standard 1872 Part 4—Cladding in artificial stone—Gluing with mechanical fixing; standard 1872 part 5.1—Cladding in artificial stone—Precast and mechanical fixing; standard 1872 part 5.2.—Cladding in artificial stone—Toothed units; standard 2378 part 1—Cladding in stone—general demands; standard 2378 part 2—cladding in stone—wet cladding; standard 2378 part 3—cladding in stone—dry cladding; standard 2378 part 4—cladding in stone—gluing with mechanical fixing; standard 2378 part 5—cladding in stone—precast and on site pre casting; standard 2378 part 6—cladding in stone—double wall system; standard 6560—cladding with external thermal barrier; standard 1414 part 1—external plastering; standard 1414 part 3—External thermal plastering; and standard 1568—Ventilated facades.

All of these references are incorporated herein by reference in their entirety.

There is thus, a great need for, and it would be highly advantageous to have, a wet cladding method that will allow the advantages inherent to the method itself, allowing the use of industrialized cladding materials such as ceramic tiles, while avoiding the limitations associated with the use of stone and/or the method described in IL243159 and which complies with Israeli building standards.

### SUMMARY OF THE INVENTION

According to an aspect of the present invention, there is provided a wet cladding method for constructing a cladded wall, the method comprising:
(a) providing a plurality of wet cladding kits, each of said kits comprising:
   (i) an undercut anchor configured for being inserted into a hole formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with, said proximal end of said cementitious material engaging element, said flaring element configured for flaring said undercut anchor in said hole;
(b) providing a plurality of end cladding elements formed with holes in back surfaces thereof;
(c) providing a plurality of insulating elements;
(d) providing a formwork having an outer sheet and an inner sheet;
(e) arranging said plurality of end cladding elements with a front surface thereof against a back surface of said outer sheet of said formwork;
(f) engaging said kits in said holes;
(g) mounting said plurality of insulating elements over said end cladding elements, such that cementitious material engaging elements of said kit extend through said plurality of insulating elements, and further such that a back surface of said end cladding element and a front surface of said insulating element form intimate contact there between;
(h) securing said outer sheet of said formwork to said inner sheet of said formwork with a formwork connecting element;
   (i) applying said cementitious material between said inner sheet and said outer sheet of said formwork;
(j) allowing said cementitious material to harden with said cementitious material engaging elements penetrating therein, thereby constructing the cladded wall.

According to an aspect of the present invention, there is provided a wet cladding method for constructing a cladded wall, the method comprising:
(a) providing a plurality of wet cladding kits, each of said kits comprising:
   (i) an undercut anchor configured for being inserted into an hole formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with said proximal end of said cementitious material engaging element, said flaring element configured for flaring said undercut anchor in said hole;
(b) providing a plurality of end cladding elements formed with holes in back surfaces thereof;
(c) providing a plurality of insulating elements;
(d) arranging said plurality of end cladding elements with a front surface thereof against a back surface of a horizontal formwork;
(e) engaging said cementitious material engaging element in said holes;
(f) mounting said plurality of insulating elements over said end cladding elements, such that cementitious material engaging elements of said kit extend through said plurality of insulating elements, and further such that a back surface of said end cladding element and a front surface of said insulating element form intimate contact there between;
(g) applying said cementitious material onto said back surface of said insulating element;
(h) allowing said cementitious material to harden with said cementitious material engaging elements penetrating therein, thereby constructing the cladded wall.

According to an aspect of the present invention, there is provided a wet cladding method for constructing a cladded wall, the method comprising:
(a) providing a plurality of wet cladding kits, each of said kits comprising:
   (i) an undercut anchor configured for being inserted into an hole formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with said proximal end of said cementitious material engaging element, said flaring element configured for flaring said undercut anchor in said hole;
(b) providing a plurality of end cladding elements formed with holes in back surfaces thereof;
(c) providing a plurality of insulating elements;
(d) applying cementitious material into a horizontal formwork;
(e) engaging said cementitious material engaging element in said holes;
(f) mounting said plurality of insulating elements over said end cladding elements so as to generate insulated end cladding elements, such that cementitious material engaging elements of said kit extend through said plurality of insulating elements, and further such that a back surface of said end cladding element and a front surface of said insulating element form intimate contact therebetween;
(g) placing said insulated end cladding elements with a back surface thereof onto said cementitious material; and
(h) allowing said cementitious material to harden with said cementitious material engaging elements penetrating therein, thereby constructing the cladded wall.

According to an aspect of the present invention, there is provided a method of wet cladding a backup wall, the method comprising:
(a) providing a plurality of wet cladding kits, each of said kits comprising:
   (i) an undercut anchor configured for being inserted into an hole formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with, said proximal end of said cementitious material engaging element, said flaring element configured for flaring said undercut anchor in said hole;
(b) providing a plurality of end cladding elements formed with holes in back surfaces thereof;
(c) providing a plurality of insulating elements;
(d) engaging a reinforcement metal mesh onto a backup wall to be cladded;
(e) engaging said kits in said holes;
(f) mounting said plurality of insulating elements over said end cladding elements, such that cementitious material engaging elements of said kit extend through said plurality of insulating elements, and further such that a back surface of said end cladding element and a front surface of said insulating element form intimate contact there between;
(g) applying said cementitious material between said back surfaces of said plurality of insulating elements and said backup wall with said cementitious material engaging elements penetrating into the cementitious material; and
(h) allowing said cementitious material to harden with said cementitious material engaging elements penetrating therein, thereby wet cladding the backup wall.

According to an aspect of the present invention, there is provided a wet cladding method for constructing a cladded wall, the method comprising:
(a) providing a plurality of wet cladding kits, each of said kits comprising;
   (i) an undercut anchor configured for being inserted into an hole formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with, said proximal end of said cementitious material engaging element, said flaring element configured for flaring said undercut anchor in said hole;
(b) providing a plurality of end cladding elements formed with holes in back surfaces thereof;
(c) providing a plurality of insulating elements;
(d) providing a formwork having an outer sheet and an inner sheet;
(e) arranging said plurality of end cladding elements with a front surface thereof against a back surface of said outer sheet of said formwork;
(e) engaging said cementitious material engaging element in said holes;
(f) mounting said plurality of insulating elements over said end cladding elements such that said cementitious material engaging element extends through said plurality of insulating elements, wherein a back surface of said end cladding element is positioned in intimate contact with a front surface of said insulating element;
(g) securing said plurality of end cladding elements to said outer sheet of each said formwork so as to form a plurality of assemblages;
(h) hoisting said plurality of assemblages to a floor under construction and placing said plurality of assemblages adjacent to one another;
(i) placing a plurality of reinforcing elements against said back surface of said plurality of end cladding elements;
(j) connecting each said inner sheet and each respective said outer sheet of said plurality of formworks to one another with formwork connecting elements, so as to form a continuous formwork unit;
(k) applying said cementitious material into said continuous formwork unit; and
(l) allowing said cementitious material to harden with said cementitious material engaging element penetrating therein, thereby constructing a cladded wall.

According to embodiments of the invention, the hole is an undercut hole.

According to embodiments of the invention, the hole is defined by internal walls having a length and a substantially identical diameter along said length, said end cladding element being fabricated from a material having a plasticity and a retention force that allows flaring of said undercut anchor beyond said hole.

According to embodiments of the invention, the material has a plasticity and is sufficiently non-brittle, so as to allow flaring of said undercut anchor into said material without breaking said end-cladding element, said material having a retention force that allows rigid attachment of said undercut anchor to said end-cladding element.

According to embodiments of the invention, the end cladding element is fabricated from a cement board.

According to embodiments of the invention, the cement board is a cement bonded particle board or a cement fibre board.

According to embodiments of the invention, the wet cladding kits further comprise a load dispersion element connectable to, or integrally formed with, said flaring element or said undercut anchor, wherein said load dispersion element is configured to disperse load over a surface area of said load dispersion element, wherein said surface area is at least twice the surface area of said hole, so as to reduce load imposed by said undercut anchor on walls defining said hole.

According to embodiments of the invention, the load dispersion element is positioned between said back surface of said end cladding element and said front surface of said insulating elements.

According to embodiments of the invention, the insulating elements are thermal insulating elements and/or acoustic insulating elements.

According to embodiments of the invention, the method further comprises fastening said insulating elements to said end cladding elements with a fastening piece.

According to embodiments of the invention, the fastening piece comprises:
a plate section;
a bore extending through said plate section for receiving said cementitious material engaging element; and
at least one prong extending out from said plate section;
wherein said fastening piece is configured to be fixed in the cementitious material when the cementitious material hardens and to engage said insulating element positioned on said back surface of the end cladding element.

According to embodiments of the invention, the method further comprises temporarily securing said end cladding element to said outer surface of said formwork with a securing plate and a removable end cladding element securing agent following said arranging and prior to said applying.

According to embodiments of the invention, the removable end cladding element securing agent is a metal screw.

According to embodiments of the invention, the securing plate is not connected to an end cladding element spacer element or not integral to an end cladding element spacer element.

According to embodiments of the invention, the method further comprises attaching water sealing strips to said back surface of adjacent end cladding elements prior to said applying.

According to embodiments of the invention, the applying is effected with a concrete pump.

According to embodiments of the invention, the method further comprises ultrasonically vibrating said cementitious material before said cementitious material is hardened.

According to embodiments of the invention, the arranging comprises spacing said plurality of end cladding elements with spacers spaced on said back surface of said outer sheet of said formwork, wherein said spacers are integral to or permanently attached to said formwork.

According to embodiments of the invention, the method further comprises placing a reinforcement metal mesh between said plurality of end cladding elements and said inner sheet of said formwork.

According to embodiments of the invention, the method further comprises removing said formwork.

According to embodiments of the invention, the method further comprises removing cementitious material leakages from a front surface of said plurality of end cladding elements.

According to embodiments of the invention, the method further comprises:
(k) arranging an additional set of end-cladding elements with a front surface thereof against a back surface of an inner sheet of said formwork; and
(l) connecting cementitious material engaging elements with said end-cladding elements of said additional set, wherein steps (k) and (l) are carried out prior to step (h).

According to embodiments of the invention, the method further comprises:
(m) arranging an additional set of end-cladding elements with a front surface thereof against a back surface of an inner sheet of said formwork; and
(n) connecting cementitious material engaging elements with said end-cladding elements of said additional set, wherein steps (k) and (l) are carried out prior to step (j).

According to embodiments of the invention, the additional set of end-cladding elements are fabricated from a cementitious material.

According to embodiments of the invention, the additional set of end-cladding elements comprise pre-fabricated cement boards.

According to embodiments of the invention, the pre-fabricated cement boards are cement bonded particle boards or cement fiber boards.

According to embodiments of the invention, the connecting is via holes that are formed in back surfaces of said additional set of end-cladding elements into which undercut anchors have been inserted.

According to embodiments of the invention, the holes are undercut holes.

According to embodiments of the invention, the holes are defined by internal walls having a length and a substantially identical diameter along said length.

According to embodiments of the invention, the connecting is via holes that are formed in sides of said additional set of end-cladding elements.

According to embodiments of the invention, the method further comprises mounting, prior to step (h), a layer being of a material that is softer than said end-cladding element, over said end-cladding elements of said additional set, such that said cementitious material engaging element traverses and extends beyond a thickness of said layer, and further such that a back surface of said end-cladding element of said additional set and a front surface of said layer form intimate contact therebetween.

According to embodiments of the invention, the method further comprises mounting, prior to step (j), a layer being of a material that is softer than said end-cladding element, over said end-cladding elements of said additional set, such that said cementitious material engaging element traverses and extends beyond a thickness of said layer, and further such that a back surface of said end-cladding element of said additional set and a front surface of said layer form intimate contact therebetween.

According to embodiments of the invention, the material of said layer is an insulating material.

According to embodiments of the invention, the combined thickness of said layer and said end-cladding element of said additional set is at least 4.5 cm.

According to embodiments of the invention, the insulating material is a heat insulating material.

According to embodiments of the invention, the material of said layer is polystyrene or Styrofoam.

According to an aspect of the present invention, there is provided a structure constructed using the methods described herein.

According to an aspect of the present invention, there is provided a cladded structure comprising:
(a) a plurality of cementitious material engaging elements;
(b) a plurality of end cladding elements having a front surface and a back surface, wherein said back surface comprises at least one hole;
(c) a plurality of insulation elements having a front surface and a back surface, mounted on said back surface of said plurality of end cladding elements such that a front surface of said insulation elements are in intimate contact with said back surface of said end cladding elements; and
(d) hardened cementitious material;
wherein said plurality of cementitious material engaging elements are engaged in said hardened cementitious material via said hole, thereby providing mechanical fixing of the insulated end cladding elements to said hardened cementitious material.

According to embodiments of the invention, the structure further comprises water sealing strips attached on said back surface of adjacent said end cladding elements configured to seal gaps between said adjacent end cladding elements configured to water seal the structure once said cementitious material is hardened.

According to embodiments of the invention, the structure further comprises a plurality of load dispersion elements positioned between said end cladding elements and said insulation elements, said load dispersion elements being configured to disperse load over a surface area of said load dispersion element, wherein said surface area is at least twice the surface area of said hole, so as to reduce load imposed by said undercut anchor on walls defining said hole.

According to embodiments of the invention, the structure further comprises a plurality of insulating element fastening pieces, said fastening pieces being threaded through said cementitious material engaging elements.

According to embodiments of the invention, the fastening piece comprises:
a plate section;
a bore extending through said plate section for receiving said cementitious material engaging element; and
at least one prong extending out from said plate section;
wherein said fastening piece is configured to be fixed in the cementitious material when the cementitious material hardens and to engage said insulating element positioned on said back surface of the end cladding element.

According to embodiments of the invention, the structure further comprises securing plates positioned over back surface of adjacent said end cladding elements.

According to embodiments of the invention, the securing plates are fabricated from a metal.

According to embodiments of the invention, the structure is a concrete wall.

According to embodiments of the invention, the concrete wall is an outer wall of a building.

According to embodiments of the invention, the structure is cladded on an exterior facing surface thereof.

According to embodiments of the invention, the structure is cladded on an interior facing surface thereof.

According to embodiments of the invention, the hole is an undercut hole.

According to embodiments of the invention, the hole is defined by internal walls having a length and a substantially identical diameter along said length.

According to embodiments of the invention, the end-cladding element for cladding said interior facing surface is lined with a layer being of a material that is softer than said end-cladding element, said cementitious material engaging element traversing and extending beyond a thickness of said layer, wherein said back surface of said end-cladding element for cladding said interior facing surface and a front surface of said layer form intimate contact there between.

According to embodiments of the invention, the material of said layer is an insulating material.

According to embodiments of the invention, the combined thickness of said layer and said end-cladding element for cladding said interior facing surface is at least 4 cm.

According to embodiments of the invention, the insulating material is a heat insulating material.

According to embodiments of the invention, the material of said layer is polystyrene or Styrofoam.

According to embodiments of the invention, the insulating elements are thermal insulating elements and/or acoustic insulating elements.

According to embodiments of the invention, the structure is selected from the group consisting of a precast wall, a wall and a building.

According to embodiments of the invention, the structure further comprises a corner bracket connecting a pair of said plurality of end cladding element to one another at an angle.

According to embodiments of the invention, at least one of said plurality of cladding elements is a quadrangle having X and Y dimensions, whereby both X and Y are each independently greater than 35 cm.

According to embodiments of the invention, at least eleven kits are provided per 35 kg of end cladding element.

According to embodiments of the invention, a pulling strength of said cladding element is at least 100 Kg/m².

According to an aspect of the present invention, there is provided a method of securing an undercut anchor in a blind hole which traverses a thickness of an end-cladding element, said blind hole having an opening on a back surface of said end-cladding element, said blind hole being defined by internal walls having a length and a substantially identical diameter along said length, the method comprising:
inserting said undercut anchor into said blind hole;
screwing a flaring element into said undercut anchor, so as to allow said undercut anchor to flare inside said hole and beyond said internal walls of said hole, while compressing material of said end-cladding element surrounding said hole.

According to embodiments of the invention, end-cladding element is fabricated from a material having a plasticity and being sufficiently non-brittle, so as to allow flaring of said undercut anchor beyond said walls of said hole without breaking said end-cladding element, said material having a retention force that allows rigid attachment of said undercut anchor to said end-cladding element.

According to embodiments of the invention, flaring element is integrally formed with, or attachable to, an undercut anchor (UA) attaching end of a cementitious material engaging element.

According to embodiments of the invention, end-cladding element is fabricated from a pre-prefabricated cementitious material.

According to embodiments of the invention, end-cladding element is a pre-fabricated cement board.

According to embodiments of the invention, pre-fabricated cement board is a cement bonded particle board or a cement fiber board.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B and 1C are illustrations of three stages in preparation of end cladding element assemblies as depicted in IL 243159;

FIG. 2A is an illustration of an insulating element as depicted in IL 243159;

FIG. 2B is an illustration of a stage in the construction of an exterior insulated wall as depicted in IL 243159;

FIG. 3A is an exemplary system including a cementitious engaging element, a flaring element, an undercut anchor and an end cladding element having an undercut hole on the back surface thereof;

FIGS. 3B, 3C and 3D are exemplary systems including a cementitious engaging element attached to a flaring element and an undercut anchor;

FIGS. 4A, 4B and 4C are different views of an example load dispersion element in accordance with some exemplary embodiments of the invention;

FIG. 5A is a back view of an exemplary insulating element fastening piece attached to the back surface of an insulating element;

FIG. 5B is a simplified drawing of an insulating element fastening piece according to exemplary embodiments of the invention;

FIG. 6A is a back view of an exemplary insulating element fastening piece attached to the back surface of an insulating element;

FIG. 6B is a simplified drawing of an insulating element fastening piece according to exemplary embodiments of the invention;

FIG. 7 is a simplified drawing of a system including an end cladding element, two non-identical insulating elements and an insulating element fastening piece according to exemplary embodiments of the invention;

FIG. 8 is a simplified drawing of a system including an end cladding element, an insulating element, a load dispersion element and an insulating element fastening piece according to exemplary embodiments of the invention;

FIGS. 9A-B are front and back views of securing plate assembly securing end cladding element to an outer sheet of a formwork over gaps covered with a sealing strip in accordance with some exemplary embodiments of the invention;

FIGS. 10A, 10B and 10C are different views of a securing plate assembly securing end cladding elements to an outer sheet of a formwork over gaps covered with a sealing strip in accordance with some exemplary embodiments of the invention;

FIG. 10D is a simplified drawing of a temporary securing plate securing agent.

FIG. 11 is a photograph depicting removal of cement stains on the surface of a stone end cladding elements when the cladded wall has been cast according to the Baranovich method;

FIG. 12A is an example assembled corner system in accordance with some exemplary embodiments;

FIG. 12B is a blow out of the corner bracket used in the exemplary corner system illustrated in FIG. 12A;

FIG. 13 is a simplified flow chart of an example method for simultaneous wet cladding and insulating in accordance with some exemplary embodiments of the invention;

FIG. 14 is a simplified flow chart of an example method for simultaneous wet cladding and insulating in accordance with some exemplary embodiments of the invention;

FIG. 15 is a simplified flow chart of an example method for simultaneous wet cladding and insulating in accordance with some exemplary embodiments of the invention;

FIG. 16 is a simplified flow chart of an example method for simultaneous wet cladding and insulating in accordance with some exemplary embodiments of the invention;

FIGS. 17A-B is a simplified flow chart of an example method for simultaneous wet cladding and insulating in accordance with some exemplary embodiments of the invention;

FIGS. 18A and 18B and 18C are illustrations of three stages in preparation of end-cladding element assemblies with uniform (non-undercut) holes, according to embodiments of the invention;

FIGS. 19A and 19B and 19C are illustrations of three stages in preparation of end-cladding element assemblies with undercut holes, according to embodiments of the invention;

FIG. 20 is an illustration of a wall which is cladded on both the internal-facing surface and the external-facing surface, according to embodiments of the invention;

FIGS. 21A, 21B, 21C and 21D are respectively an alternate example system including an example kit with an example U-shaped element, two perspective views of the example kit and a sectional view of the example kit installed on an edge of an end cladding element, all in accordance with some example embodiments;

FIGS. 22A, 22B and 22C are two perspective views of another example kit with a U-shaped element and a sectional view of the example kit installed on an edge of an end cladding element, all in accordance with some example embodiments; and

FIGS. 23A and 23B are respectively a perspective view and a side view of yet another example kit including a U-shaped piece in accordance with some example embodiments.

### DESCRIPTION OF SPECIFIC EMBODIMENTS OF THE INVENTION

The present invention, in some embodiments thereof, relates to methods of constructing insulated walls by wet cladding, kits and systems capable of same and insulated, structures cladded therewith.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

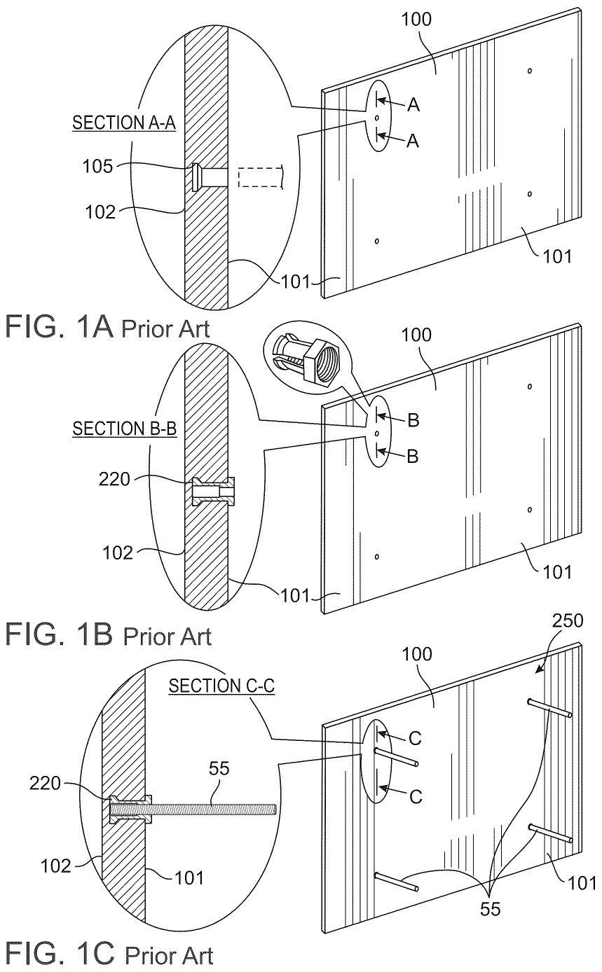

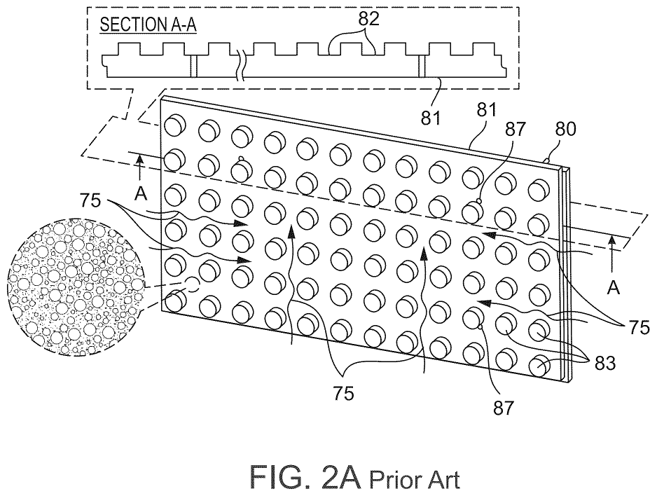

Reference is first made to FIGS. 1A-C and FIGS. 2A-B, as presented in IL 243159, which relates to a wet cladding system for constructing ventilated exterior walls of buildings.

FIG. 1A illustrates an undercut hole 105 formed on back surface 101 of end cladding element 100. End cladding element 100 has an exterior facing surface 102.

FIG. 1B illustrates an undercut anchor 220 positioned in the undercut hole 105.

FIG. 1C illustrates a cementitious material engaging element 55 having at its proximal end a flaring element 260 inserted into the undercut anchor 220 of the end cladding element 100, thereby forming an end cladding element system 250.

FIG. 2A illustrates an insulating element 80 which includes an inward facing surface 81 and an outward facing surface 82. The outward facing surface 82 is formed with an array of mutually spaced protrusions 83 which define air-flow pathways there between, as indicated by arrows 75. A plurality of pre-drilled holes 87 are positioned and sized to accommodate the cementitious material engaging element 55, which extends through the insulating element 80.

As seen in FIG. 2B, the insulating element 80 is mounted over the end cladding element system, 250, with outward facing surface 82 facing end cladding element system 100, such that the cementitious material engaging element 55 extends through pre-drilled holes 87 in the insulating elements 80. The insulating elements are connected to one another through a joint 89. The back surface of the end cladding element 101 and the outward facing surface of the insulating element 82 are not in intimate contact throughout because of the mutually spaced protrusions.

The present invention overcomes the disadvantages of the wet cladding system described in IL 243159.

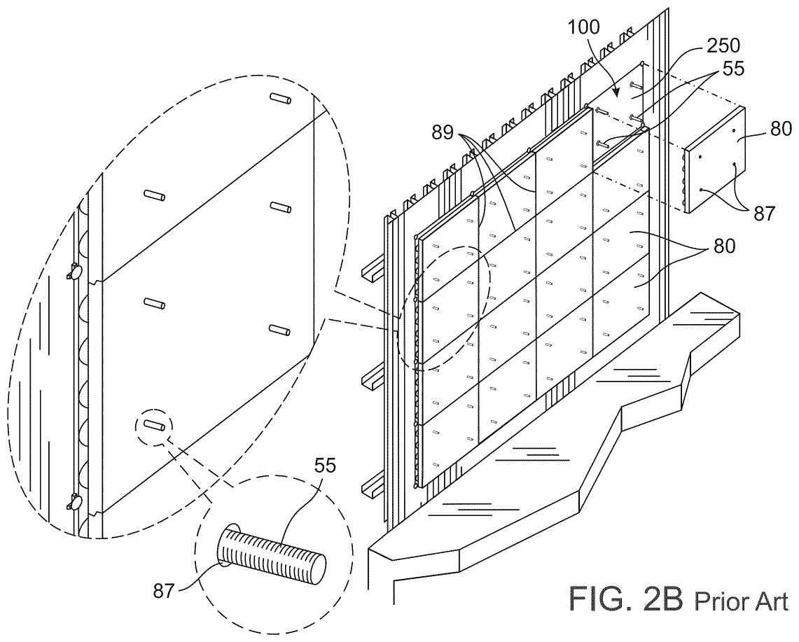

For purposes of better understanding some embodiments of the present invention, reference is now made to FIGS. 3A-D showing components of a non-assembled system, all in accordance with some exemplary embodiments. FIG. 3A shows a system 250, which includes an end cladding element 100 having a back surface 101 and at least one hole e.g., undercut hole 105. The system 250 further includes an undercut anchor 220 configured to be received in the hole e.g. undercut hole 105 formed on back surface 101 of end cladding element 100, a flaring element 260 and a cementitious material engaging element, e.g., engaging element 55 configured for wet cladding.

A wet cladding kit according to exemplary embodiments includes an undercut anchor 220, flaring element 260 and cementitious material engaging element 55.

The cementitious material engaging element 55 has an elongated structure having a proximal end and a distal end.

The term “proximal end” refers to the end, which after engagement is closest to the end cladding element. The proximal end of the cementitious material engaging element may be referred to as the undercut anchor attaching end. The tern “distal end” refers to the end, which after engagement is furthest from the end cladding element. The distal end of the cementitious material engaging element may be referred to as the cement embedding (CE) end.

In exemplary embodiments at least 11 kits are provided per about 35 kg of end cladding element. In exemplary embodiments at least 11 kits are provided per about 1 m² of end cladding element.

According to exemplary embodiments, each corner of the end cladding element (e.g., tile) is connected to at least one kit on its back surface, e.g., at least four kits per tile. Depending on the size of the end-cladding elements, additional kits may be required or desired.

According to exemplary embodiments, end cladding element 100 includes four holes, e.g. undercut holes 105, one for each corner of end cladding element 100.

The flaring element 260 and the proximal end 56 of the cementitious material engaging element 55 are configured such that they are directly or indirectly connectable to form a firm, rigid connection (in the absence of the cementitious material). Thus, for example, the flaring element 260 may include a threading 60 on one end such that it can be screwed into a bore formed through the proximal end 56 of the engaging element 55. In another embodiment, the flaring element 260 may be pinned into a bore formed through the proximal end 56 of said cementitious material engaging element 55. In another embodiment, the flaring element 260 is integrally formed with the cementitious material engaging element 55, as illustrated in FIGS. 3B-3D.

The flaring element 260 may also include a threading 60 on its opposite end, as illustrated in FIGS. 3A-3D such that it can be screwed into a bore of the undercut anchor 220. According to some additional exemplary embodiments, flaring element 260 may be a rod that is configured to flare undercut anchor 220 based on being pushed or hammered into undercut anchor 220.

According to a particular embodiment, the cementitious material engaging element 55 has a normal vector component in the distal end 57 which, during service, is positioned parallel to the end cladding element 100.

According to exemplary aspects of some embodiments of the invention, the normal vector component is formed, at least in part, by selecting the distal end of the cementitious material engaging element with a bend. In some exemplary embodiments, system 250 include cementitious material engaging elements 55 formed with a 90 degree bend. In other exemplary embodiments, illustrated in FIG. 3D, system 250 includes engaging elements 55 with distal end 57 similar to the distal end of engaging elements 55 used in the Baranovich method.

According to exemplary aspects of some embodiments of the invention, the cementitious material engaging element is threaded at the distal end and wherein the normal vector component is formed at least in part by a threaded surface of the distal end. The threading 60 on the distal portion of the cementitious material engaging element 55 is illustrated in FIGS. 3A and 3B.

The distal end (e.g., pin) of the engaging elements 55 may be the same or similar to the metal pins described in section 2378 Part 2 of the Israeli building standard, may be the same or similar to the metal pins described in section 2378 Part 5 of the Israeli building standard. In some exemplary embodiments of the invention the engaging element may be formed from a stainless steel rod that has a diameter of at least 3 mm-4 mm, e.g., 3.5 mm. According to some exemplary embodiments, larger diameter engaging elements may be used. The length of the part of the cementitious material engaging element that actually engages the cement or concrete may be between 50-100 mm for example, between 60-80 mm.

The pull strength of the kits in the undercut hole is several orders of magnitude higher as compared to existing wet cladding methods where the pins are inserted into holes formed on the side surface of the stone without any undercut associated pull resistance. So, when using for example the Baranovich method for wet cladding, many of the pins are misplaced and find themselves spread at the bottom of the wall, reducing the mechanical fixing of the facade to the backup wall as a whole. The present invention overcomes this limitation by affording an undercut engagement for attachment of the cementitious material engaging element (pin) which creates a far stronger mechanical connection between the pin and the end cladding element, allowing the use of concrete pumps and sonicators.

According to an exemplary embodiment of the invention the pulling strength of the cementitious material engaging element from an end cladding material is selected over 10 Kg pull strength, optionally over 20 Kg pull strength, optionally over 40 Kg pull strength optionally about 10 Kg pull strength. According to an exemplary embodiment of the invention the pulling strength of an end cladding element from a cladded wall is at least 100 Kg/m², optionally at least 500 Kg/m², optionally at least 1000 Kg/m², optionally at least 1500 Kg/m², optionally at least 2000 Kg/m², optionally at least 2300 Kg/m².

According to some exemplary embodiments, the end cladding elements may be pre-formed with the hole (e.g., undercut hole or uniform hole), e.g., during manufacturing. The uniform hole is a blind hole being defined by internal walls having a length and a substantially identical diameter along the length. In an exemplary embodiment, the hole (e.g., undercut hole or uniform hole) is about 5-7 mm in diameter and about 4-7 mm in depth. According to exemplary embodiments, the end cladding element is formed with a plurality of holes (e.g., undercut holes, e.g., 4-8, 4-12 or 4-50 holes (e.g., undercut holes).

The end cladding elements which can be used in the present invention have a wide range of thicknesses less than 3 cm, e.g., 1 cm-3 cm, less than 2 cm, e.g., 1.9 cm or less, or even 9-12 mm. According to some exemplary embodiments, end cladding elements are porcelain or ceramic tiles. The end cladding elements may be fabricated from other man-made (i.e., synthetic) materials (such as high pressure laminate (HPL), concrete, Corian®, Caesarstone*), glass, clay or with slate. It will be appreciated that when a non-undercut hole is drilled into the back surface of the end cladding element, the end cladding element is fabricated from a material having a plasticity and being sufficiently non-brittle, so as to allow flaring of the undercut anchor beyond the walls of the hole without breaking the end-cladding element, the material having a retention force that allows rigid attachment of the undercut anchor to said end-cladding element. Examples of such materials include pre-fabricated cementitious materials including pre-fabricated cement boards.

According to some exemplary embodiments of the invention, the end cladding element may have a water absorption of less than 0.5%. The end cladding elements may be of any shape (e.g., a polygon, such as rectangular or square; or combination of polygons having, for example, 5 and 6 gons to clad curved surfaces; or a non-polygon) and of any size—e.g., between 20 cm-5 meters in length and between 20 cm to 5 meters in height. According to some exemplary embodiments at least one of said plurality of cladding elements is a quadrangle having X and Y dimensions, whereby both X and Y are each independently greater than 35 cm. The back surface of the end cladding element may be smooth or rough.

In an exemplary embodiment, at least eleven kits are used per square meter of the end cladding element.

In an exemplary embodiment, the front surface of the end cladding elements are lined with a protective cover. According to some exemplary embodiments the protective cover is configured to protect the front surface of the end cladding element from being soiled with cementitious material during casting. The protective cover may be fabricated from any material (e.g., nylon) that is removable once the cladding or cladded wall construction is completed.

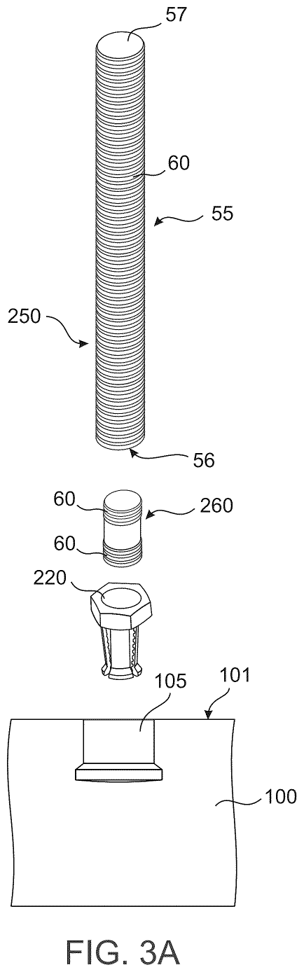

Additional components required to construct the wet-cladded and insulated walls according to embodiments of the present invention are further described herein below and illustrated in FIGS. 4A-C, 5A-B, 6A-B and 9A-B.

### Load Dispersion Element:

The load dispersion element allows wet cladding with softer and/or more brittle end cladding materials, with lesser risk of damaging the walls defining the hole (e.g., undercut hole) when a torque is applied to the cementitious material engaging element, while maximizing the load bearing attachment between the cementitious material engaging element and the end cladding element. The load dispersion element is placed tightly against the back surface of the end cladding element to relieve lateral forces and blows by spreading the force over a larger surface area.

FIGS. 4A, 4B and 4C are different views of an exemplary load dispersion element in accordance of some exemplary embodiments. According to some exemplary embodiments, load dispersion element 300 is positioned against back surface 101 of an end cladding element 100 over an undercut anchor 220. In some exemplary embodiments, lateral forces applied on cementitious material engaging element 55 may be partially spread over a surface area of load dispersion element 300. According to some exemplary embodiments, load bearing element 300 is a pressure relieving washer including a central bore 303. According to some exemplary embodiments, a nut element 262 is fitted in the central bore. In some exemplary embodiments, central bore 303 has a polygon shape, e.g., pentagonal for receiving nut element 262 and resisting rotation between nut element 262 in bore 303. Load dispersion element 300 is shown to have a pentagonal shape. Other shapes, e.g., rectangular, round, and hexagonal are also contemplated. In some exemplary embodiments, flaring element 260 may penetrate nut element 262 with a threaded engagement. The threaded engagement reinforces the pressure of the load dispersion element 300 against back surface 101 of end cladding element 100.

According to some exemplary embodiments, load dispersion element 300 is metal. In some exemplary embodiments, load dispersion element 300 has a width or diameter of 20 mm-70 mm, e.g., 40 mm and a bore with a diameter that is 5 mm-20 mm, e.g., 10 mm.

In one embodiment, the load dispersion element covers a surface area which is at least twice, at least three times or even four times the surface area of the hole (e.g., undercut hole).

According to some exemplary embodiments of the invention, the load dispersion element is integrally formed with the flaring element or the undercut anchor and is pressed against the back surface of the end cladding element surrounding the hole (e.g., undercut hole).

### Insulating Element and Fastening Piece:

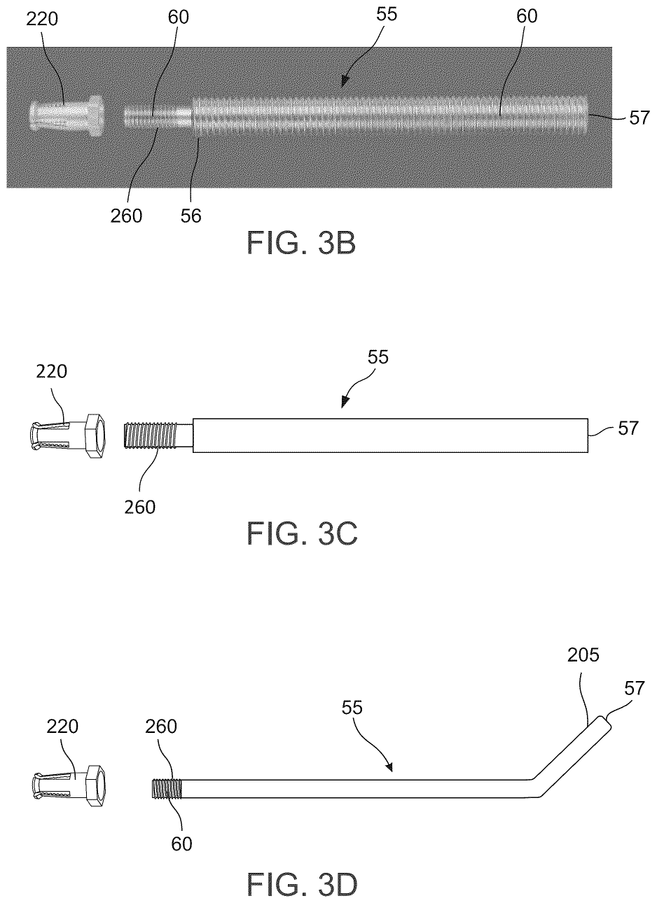

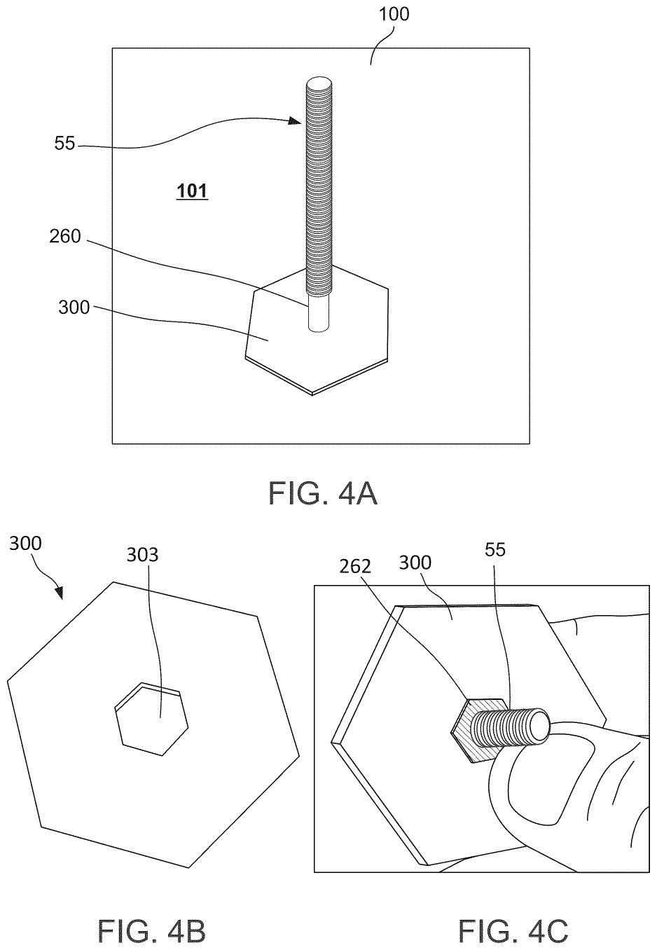

FIGS. 5A and 6A illustrate system 450 which includes fastening pieces 360, in accordance with some example embodiments. Fastening piece 360 are configured to secure an insulating element 80 against the back surface of an end cladding element 100, such that it is in intimate contact with the end cladding element 100. In one embodiment, the fastening piece 360 is configured for being mounted over and onto the distal end of the cementitious material engaging element 55.

The intimate contact between the insulating element 80 and the end cladding element 100 is such that it is continuous over the entire surface area of the insulating element 80. In one embodiment, at least 60%, 70%, 80%, 90% or even 95% of the surface area of the end cladding element is in intimate contact with the insulating element.

In one embodiment, the intimate contact is such that it does not allow air to flow between the insulating element 80 and the end cladding element 100.

Optionally fastening piece 360 includes a plate section 361, a bore 363 extending through plate section 361 at prongs 362 extending out from plate section 361. Prongs 362 may engage the cementitious material while wet and may provide an improved attachment of the system to the cementitious material when dried. Prongs 362 may be relatively short prongs as shown in FIG. 5B or alternatively long prongs 362 as shown in FIG. 6B. Optionally, fastening piece 360 may include a combination of different sized prongs 362.

The dimensions of the fastening piece may be such that it serves as an additional load dissipater (i.e., additional to the load dispersion element which is positioned between the insulating element and the end cladding element). In one embodiment, the force on the hole (e.g., undercut hole) may be dissipated by both the prongs and the plate section of the fastening piece. The fastening piece relieves lateral forces on the hole (e.g., undercut hole) by spreading the force over a larger surface area, both into the depth of the wall (i.e., by the prongs penetrating into the wall) and behind the wall (by the plate section).

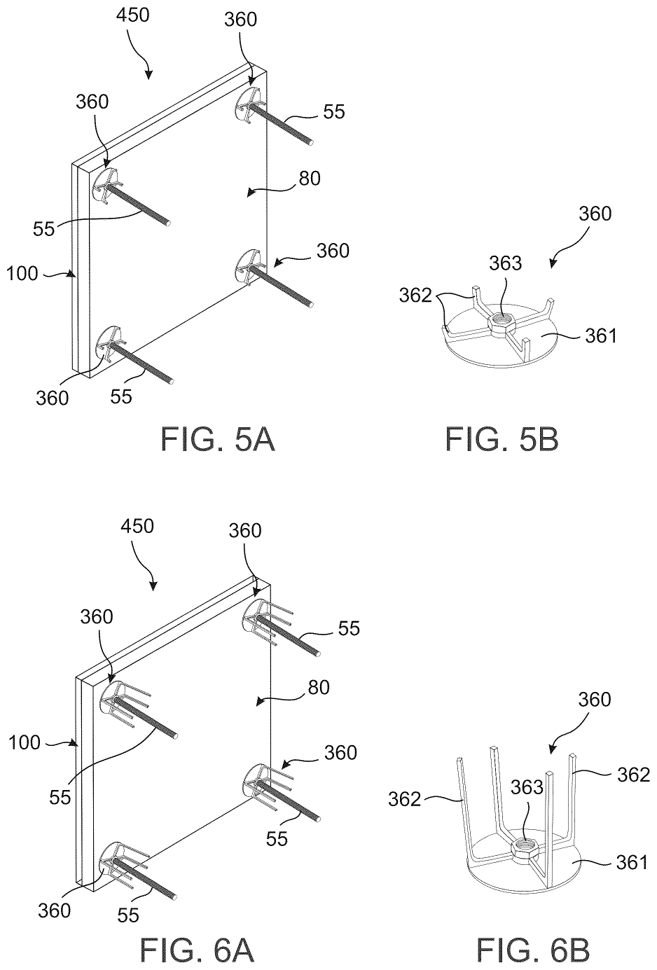

Reference is now made to FIG. 7 which shows a system 450, whereby the fastening piece 360 may be used to fasten more than one insulating element to the back surface of the end cladding element 100. In this figure, two insulating elements 80 and 85 are illustrated.

Insulating element 80 may be for example a thermal insulating element and insulating element 85 may be an acoustic element. Optionally, the insulating 80 and 85 are sized to cover a back surface of the end cladding element 100 and include holes through which the cementitious material engaging element 55 on the back surface can penetrate therethrough. The cementitious material engaging element 55 with the fastening piece may secure the insulating layer against the back surface of the end cladding element. In other example embodiments, the insulating layer 85 and/or 80 is pre-fabricated onto the back surface of the cladding element 100 and is an integral part of the end cladding element. The insulating layer may be for example a polyethylene foam with aluminum film or an aerogel mat. The acoustic element may be fabricated from an acoustic foam, mineral wool, rock wool, or fiberglass.

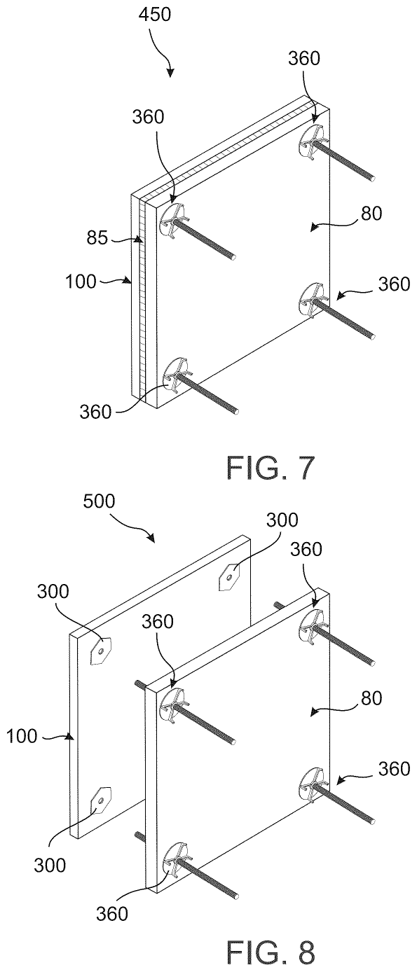

Reference is now made to FIG. 8 which shows a system 500, whereby the fastening piece 360 may be used to fasten an insulating element 80 to the back surface of the end cladding element 100 and a load dispersion element 300 is used to protect the hole (e.g., undercut hole) of the end-cladding element 100. The load dispersion element is positioned between the end cladding element 100 and the insulating element 80.

### Securing Plate and Water Sealable Strips:

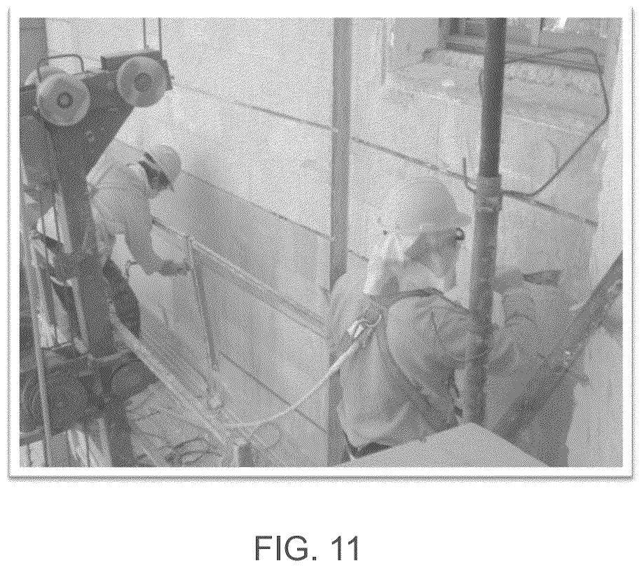

The present inventors further contemplate sealing gaps formed between adjacent end cladding elements of the cladding layer on the exterior facing surface of walls. During construction, this limits the amount of liquid cement that can spill through gaps formed between adjacent end cladding elements and soil the front surface thereof. FIG. 11 is a photograph showing workers cleaning a cladded wall constructed using the classical Baranovich method, this is both time consuming and expensive. During service, it limits the amount of water (e.g., rainfall) that can leak through gaps formed between adjacent end cladding elements and be absorbed the underlying backup wall, damaging the mechanical fixing and chemical bonding of the end cladding elements to the underlying backup wall and damaging the underlying wall itself. If not water sealed, a backup wall can absorb a substantial amount of water, reducing its inherent thermal insulation. By water sealing the gaps between adjacent end cladding elements, the underlying wall does not get wet and its inherent thermal insulation maintained uncompromised.

The present invention overcomes this particular problem by engaging the end cladding elements from and the back surfaces thereof and not their sides (thickness). This, in turn, allows sealing the gaps between adjacent end cladding elements, resulting in water sealing the entire cladded façade.

When wet cladding using the Baranovich method, liquids can leak not only through gaps formed between the end cladding elements in regions of the pins and in locations where the “chochla” seal is compromised, but also through the holes formed in the outer formwork sheet which serve for insertion of the barbed wire, and more so through the bolts dedicated holes.

As described in the Background section above, the barbed wire is used to tie the outer formwork sheet to the fortification metal mesh, caging the end cladding elements there between, so as to avoid misplacement of the end cladding elements upon hoisting this assemblage to a floor under construction.

The presently described methods and systems overcome this problem as the engaging elements extend from a back surface of the end cladding element and thereby do not penetrate the gaps between the end cladding elements. Based on this design, a gasket or other sealing strip may be positioned along gaps between adjacent end cladding elements for superior insulation.

In some exemplary embodiments, the system additionally includes securing plates to secure the end cladding elements against a formwork (i.e., a temporary mold into/onto which liquid concrete may be poured). In some exemplary embodiments, securing plates are mounted over edges of pairs of adjacent end cladding elements on their back surfaces. According to some exemplary embodiments, the securing plates are mounted over the sealing strip. The securing plate may be metal or other material, e.g., an acetal homopolymer such as Derlin® manufactured by DuPont in Delaware USA. According to some exemplary embodiments, the securing plate is instead of ties that are known to be used in for example the Baranovich system. In some exemplary embodiments, each of the securing plates is fixed to the formwork with a securing element that extends from a securing plate to the formwork through the spacing between the end cladding elements. According to some exemplary embodiments, if a spacer is used to space the end cladding elements, (i.e., to space one adjacent end cladding element from another and/or to space a first row of end cladding elements from a second row of end cladding elements) the securing element penetrates the spacer. According to exemplary embodiments, the securing element is configured to be removed after the casted wall has hardened and dried. In some exemplary embodiments, the securing element is a threaded element, e.g., a bolt that is secured to the formwork with a threaded nut. In some exemplary embodiments, the threaded engagement of securing element prevents leakage of the cementitious material during casting. In the Baranovich system, holes through which the ties are introduced are known to be openings that allow cement to leak through during casting. By using the system and method as described herein, this leakage may be prevented.

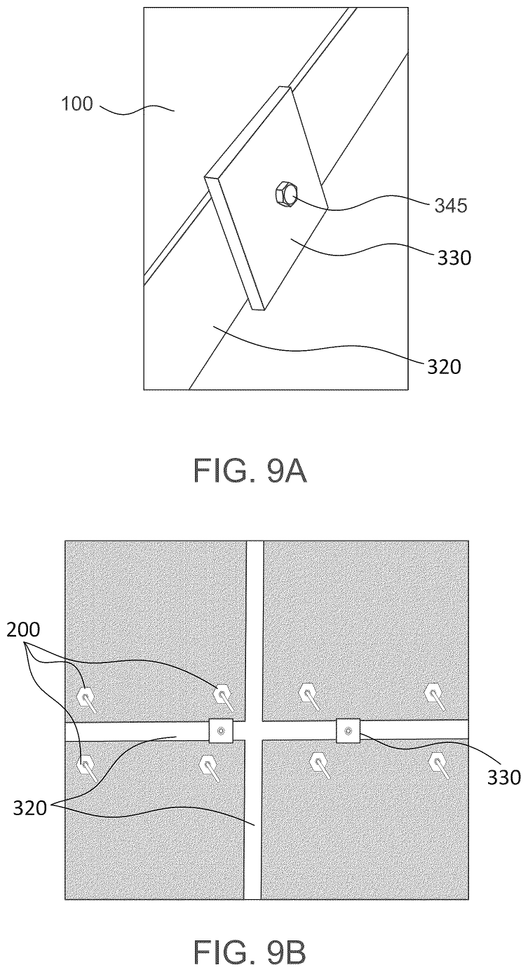

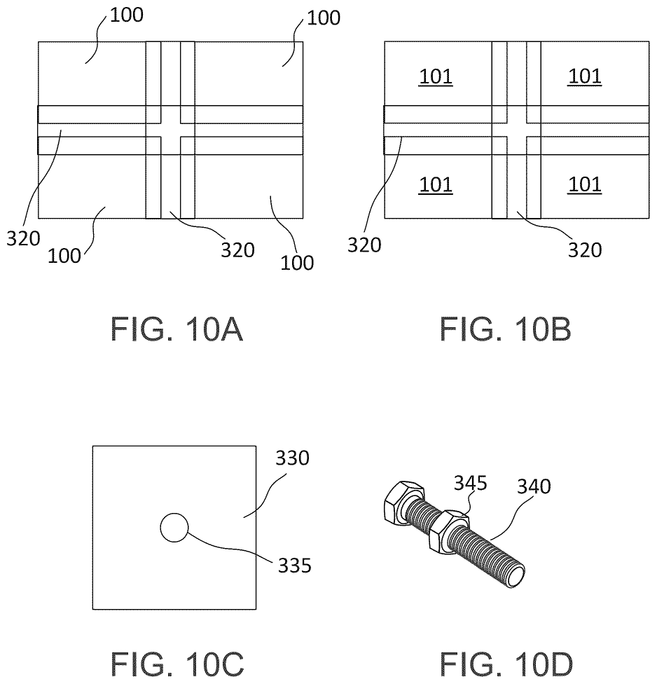

Reference is now made to FIGS. 9A and 9B showing different views of a securing plate assembly securing end cladding elements to an outer sheet of a formwork over gaps covered with a sealing strip, FIGS. 10A and 10B showing front and back views of four end cladding elements with sealing strips sealing gaps between the four end cladding elements. FIG. 10C showing an example securing plate assembly and FIG. 10D shows an exemplary removable end cladding element securing agent, all in accordance with some exemplary embodiments. According to some exemplary embodiments, sealing strips 320 are positioned over gaps between adjacent end cladding elements and are secured on back surfaces 101 of the end cladding elements. In some exemplary embodiments, sealing strips 320, provide a water impermeable seal to resist water penetrations through the gaps into the backup wall and resist leakage of cementitious material out to a front surface of the end cladding element during casting. According to some exemplary embodiments, sealing strips 320 are positioned over spacers of a formwork defining the spacing between end cladding elements. Sealing strips 320 may for example be a gasket. Since there are no pins penetrating the gaps between adjacent end cladding elements, it is possible to seal the gap with a solid material as opposed to a paste or liquid. The solid sealing may be more robust and may provide superior sealing. According to some exemplary embodiments, the sealing strip is a 1 mm Ethylene Propylene Diene Monomer (EPDM) sheet. EPDM sheets are known to be used to weather-seal roofs and are outdoor and UV rated for over 80 years of use. The sheet may be adhered to edges along back surface 101. According to some exemplary embodiments, substantially the entire surface area of back surface 101 is left exposed such that it is in intimate contact with the insulating element.

According to some exemplary embodiments, securing plates 330 are configured to support back surfaces 101 of end cladding elements against formwork panel. Securing plates 330 supports the insulated end cladding element over its edges so that back surfaces of the insulating element 80 can have substantially full contact with the cementitious material during casting. According to some exemplary embodiments, securing plates are rectangular plates with a bore 335 through which a securing element 340 is received. Securing element 340 may extend through an outer sheet of a formwork and may be fixed with a nut element 345 that engages securing element 340 with a threaded connection. According to some exemplary embodiments, the threaded connection resists leakage of cementitious material through bore 335 during casting and thereby provides a cleaner finish. In some exemplary embodiments, the securing plates 330 are used in place of the tying method used in the Baranovich system.

Securing plates 330 may be metal or may be another material that resists rust. According to some exemplary embodiments, securing plates 330 is formed with Delrin*. According to some exemplary embodiments, securing plates 330 are square with a width and height of 30 mm-90 mm, e.g., about 60 mm. According to some exemplary embodiments bore 335 is 5 mm 15 mm, e,g, 7 mm, in diameter.

After casting, securing element 340 is removed to release the outer sheet of formwork and expose the end cladding elements.

### Corner Bracket

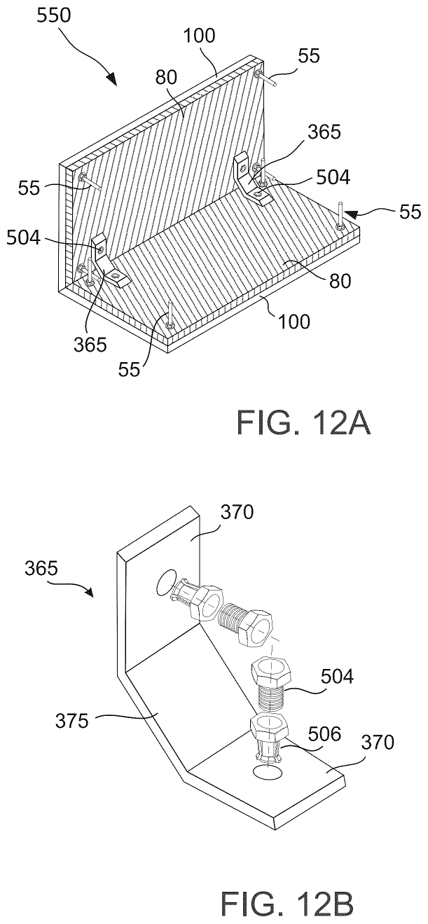

FIGS. 12A-B provide examples of assembled corner system in accordance with some exemplary embodiments. According to some exemplary embodiments, a system 550 for cladding a corner of a structure includes a pair of end cladding elements 100 attached to one another at a predetermined angle (e.g., right angles, closed angle or open angle) and secured from behind with one or more corner brackets 365. The corner structure may be the corner of building or another corner on the surface of the building—e.g., under a window, balcony, shelf etc. The corner of system 550 may be a Gerung type corner or a non-Gerung type corner. Preferably the corner structure comprises a sealant between the two end cladding elements. In some exemplary embodiments, end cladding elements 100 are formed with dedicated undercut holes configured for receiving an undercut anchor 506 and a flaring element 504 to flare the undercut anchor for fixing corner brackets 365 against end cladding elements 100. End cladding elements 100 may be additionally assembled with system 250 comprising cementitious material engaging element 55.

Thus, a kit for connecting to one another a first end cladding element to a second end cladding element at a predetermined angle is provided. The first end cladding element formed with a first undercut hole in a back surface thereof, the second end cladding element formed with a second undercut hole in a back surface thereof. The kit comprises a corner bracket having a first arm 370 having a first hole formed there through and a second arm 370 having a second hole formed there through, the first arm and the second arm connected to one another directly or indirectly via a connector element 375 at the predetermined angle. The corner bracket may be at least in part (e.g., at the connector element region) spaced from the back surfaces of the cladding elements so as to allow cementitious material to fill the space formed between the corner bracket and the cladding elements, thereby further securing the end cladding elements of the corner system to the corner of the structure.

The kit further comprises a first undercut anchor and a second undercut anchor. The kit further comprises a first flaring element and a second flaring element. The first flaring element designed insertable through the first hole for flaring the first undercut anchor within the first undercut hole. The second flaring element designed insertable through the second hole for flaring the second undercut anchor within the second undercut hole.

According to an aspect of some exemplary embodiments, elements of the system and kit are packaged and delivered to the construction site. According to some exemplary embodiments, the end cladding elements are formed with holes (e.g., undercut holes) prior to delivery of the system. According to some exemplary embodiments, the system is delivered in an assembled state or partially assembled state. According to some exemplary embodiments, the system is fully or partially assembled at the construction site.

According to an aspect of some exemplary embodiments, there is provided a structure that is cladded with the kit, system and methods described herein. The structure may be a building, a single wall, a section of a building e.g., a corner. The structure may comprise a wall which is cladded on its exterior facing surface, on its interior facing surface and optionally on both its exterior and interior facing surface.

According to an aspect of the invention, a method is provided for constructing a cladded wall. The method comprises:
(a) providing a plurality of wet cladding kits, each of said kits comprising:
   (i) an undercut anchor configured for being inserted into a hole (e.g., an undercut hole) formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with, said proximal end of said cementitious material engaging element, said flaring element configured for flaring said undercut anchor in said hole (e.g., undercut hole);
(b) providing a plurality of end cladding elements formed with holes (e.g., undercut holes) in back surfaces thereof;
(c) providing a plurality of insulating elements;
(d) providing a formwork having an outer sheet and an inner sheet;
(e) arranging said plurality of end cladding elements with a front surface thereof against a back surface of said outer sheet of said formwork;
(f) engaging said kits in said holes (e.g., undercut holes);
(g) mounting said plurality of insulating elements over said end cladding elements, such that cementitious material engaging elements of said kit extend through said plurality of insulating elements, and further such that a back surface of said end cladding element and a front surface of said insulating element form intimate contact there between;
(h) securing said outer sheet of said formwork to said inner sheet of said formwork with a formwork connecting element;
(i) applying said cementitious material between said inner sheet and said outer sheet of said formwork;
(j) allowing said cementitious material to harden with said cementitious material engaging elements penetrating therein, thereby constructing the cladded wall.

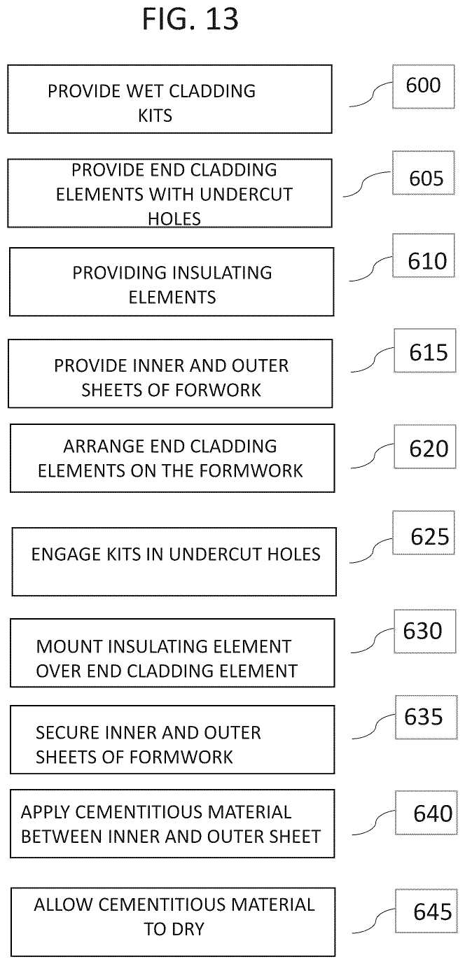

FIG. 13 is a simplified flow chart of the above described method for wet cladding and insulating a wall in accordance with some exemplary embodiments. According to some exemplary embodiments, the method includes providing a plurality of wet cladding kits (block 600), end cladding elements with holes (e.g., undercut holes) (block 605) and insulating elements (block 610) at a construction site. According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled or non-assembled system may then be used to construct an insulated, wet-cladded wall of a structure. The front surface of the end cladding elements are arranged on the back surface of the outer sheet of the formwork (block 620). According to some exemplary embodiments, the end cladding elements are spaced with spacers.

According to some exemplary embodiments, the end cladding elements are secured against the outer sheet of said formwork with securing plates. According to some exemplary embodiments, the securing plates are secured to the outer sheet of said formwork through the spacers. According to some exemplary embodiments each of the securing plates are arranged on the back surface of the end cladding elements (over the joining edge of two adjacent end cladding elements with spacers therebetween). According to some exemplary embodiments, the spacers are fixed to the outer sheet of the formwork with a screw thread connection. In some exemplary embodiments, water sealing strips are applied onto back surfaces of the end cladding elements to cover gaps between the end cladding elements. The sealing strips may seal the gaps and prevent leakage of the cementitious material onto the front surface of the end cladding elements and the outer sheet of the formwork. According to some exemplary embodiments, the securing plates are positioned over the sealing strips.

According to exemplary embodiments, the kits may then be engaged in the holes (e.g., undercut holes) (block 625).

The insulating element may be mounted over the end cladding element (block 630) such that the cementitious material engaging elements of the kit extend through the plurality of insulating element, and further such that a back surface of the end cladding element and a front surface of the insulating element form intimate contact there between, as described herein above.

The front portion and the back portion of the formwork may then be secured to one another to define a volume in which the cementitious material may be received (block 635). Reinforcements may be added to the defined volume, e.g., reinforcement bars or metal mesh. According to some exemplary embodiments, the engaging elements penetrate holes of the reinforcement metal mesh and engage with the reinforcement metal mesh.

According to some exemplary embodiments, the cementitious material is added to the defined volume (block 640) and allowed to dry (block 645). In some exemplary embodiments, the cementitious material is added with a pump pumping the cementitious material. In some exemplary embodiments, the cementitious material is added through a funnel to reduce the flow rate of the cementitious material within the volume. According to some exemplary embodiments, the cementitious material is added directly on the back surfaces of the insulating element.

After drying of the cementitious material, the inner sheet and outer sheet of the formwork may be removed. According to some exemplary embodiments, the method includes removing cementitious material leakages from a front surface of said plurality of end cladding elements.

As mentioned, the present invention further contemplates constructing walls which are cladded both on the exterior facing surface of the wall and the interior facing surface of the wall.

In one embodiment, the exterior facing surface of the wall is clad using the systems described herein (e.g. systems described in FIG. 3A, 3B, 3C or 3D). In another embodiment, the interior facing surface of the wall is clad using the systems described herein (e.g. systems described in FIG. 3A, 3B, 3C or 3D). In still another embodiment, both the interior and the exterior of the wall are clad using the systems described herein. Alternatively, either the interior or the exterior facing surface is clad using other methods known in the art including for example the Baranovich method (further described herein above) or using U-shaped elements as further described herein below.

According to this embodiment, end cladding elements (with holes in either the back surface thereof) suitable for cladding an interior facing surface are arranged on the front surface of an inner sheet of the formwork. According to some exemplary embodiments, the end cladding elements are not spaced with spacers on the formwork. According to some exemplary embodiments, the end cladding elements are secured against the inner sheet of the formwork with securing plates (as described herein above). According to some exemplary embodiments, the securing plates are fixed to the inner sheet of the formwork with a screw thread connection. Kits may then be engaged in the holes (e.g., undercut holes or uniform holes), as further described herein above.

Additional layers of material may be juxtaposed over the end-cladding elements so as to increase the thickness of the cladding element which is used to clad the interior facing surface of the wall. In one embodiment, the method comprises mounting a layer of a material that is softer than the end-cladding element, over the end-cladding elements, such that the cementitious material engaging element traverses and extends beyond a thickness of the layer, and further such that a back surface of the end-cladding element and a front surface of the layer form intimate contact there-between.

The mounting may be affected following engagement of the cementitious material engaging elements into the holes of the end-cladding elements. The mounting may be affected prior to the arranging (or securing) on the inner sheet of the formwork or following the arranging on the inner sheet of the formwork. The additional layer may have holes pre-formed therein which match the spacing of the holes of the end-cladding elements through with the cementitious material engaging elements protrude. Alternatively, the additional layer may be of a material sufficiently soft that the CMEEs can pierce the layer thereby forming the holes during the mounting itself.

According to a particular embodiment, the material of the layer is an insulating material, as further described herein above (e.g. thermal insulating material or an acoustic insulating material).

Examples of insulating materials include, but are not limited to flexible elastomeric foam, polystyrene, polyurethane, polyethylene foam, glass wool, cellulose insulation, and mineral wool. A preferred material is polystyrene or Styrofoam.

In one embodiment, the thickness of the layer is such that the combined thickness of the layer when it is in intimate contact with the end-cladding element is at least 4.5 cm, at least 5 cm or even at least 6 cm.

In another embodiment, the thickness of the layer is about 3.5 cm, 4 cm or even 4.5 cm and the thickness of the end-cladding element is between about 0.9 cm-1.2 cm. In one embodiment, the thickness of the layer serves to house utility lines or communication lines. It will be appreciated that once the concrete of the wall is set it is difficult or impossible to access the wall cavity. Accordingly, the cladded walls described herein are preformed with cavities for such lines.

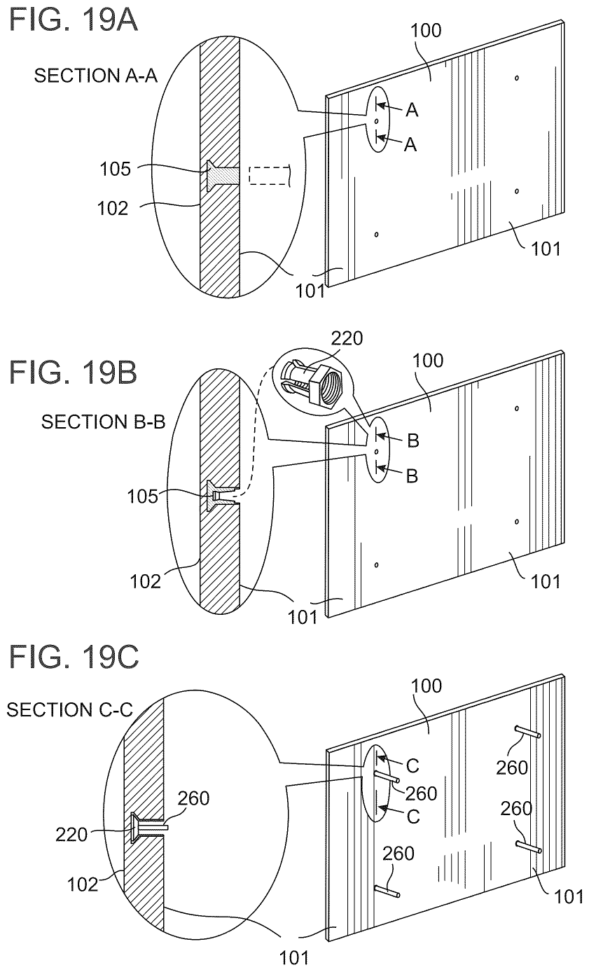

FIG. 20 is a diagram of a wall 62 which is cladded on both its interior facing surface 65 and the exterior facing surface. End-cladding element 100 suitable for cladding an exterior facing surface of the wall 62 is attached to the wall using cementitious material engaging element 55, whereas end-cladding element 120 suitable for cladding an interior facing surface of the wall 62 is attached to the wall using cementitious material engaging element 55. End cladding element 120 may be lined with an additional layer as further described herein above.

According to another aspect of the invention, a method is provided for constructing a cladded wall. The method comprises:
(a) providing a plurality of wet cladding kits, each of said kits comprising:
   (i) an undercut anchor configured for being inserted into a hole (e.g., an undercut hole) formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with said proximal end of said cementitious material engaging element, said flaring element configured for flaring said undercut anchor in said hole (e.g., undercut hole);
(b) providing a plurality of end cladding elements formed with holes (e.g., undercut holes) in back surfaces thereof;
(c) providing a plurality of insulating elements;
(d) arranging said plurality of end cladding elements with a front surface thereof against a back surface of an outer sheet of a horizontal formwork;
(e) engaging said cementitious material engaging element in said holes (e.g., undercut holes);
(f) mounting said plurality of insulating elements over said end cladding elements, such that cementitious material engaging elements of said kit extend through said plurality of insulating elements, and further such that a back surface of said end cladding element and a front surface of said insulating element form intimate contact there between;
(g) applying said cementitious material onto said back surface of said insulating element;
(h) allowing said cementitious material to harden with said cementitious material engaging elements penetrating therein, thereby constructing the cladded wall.

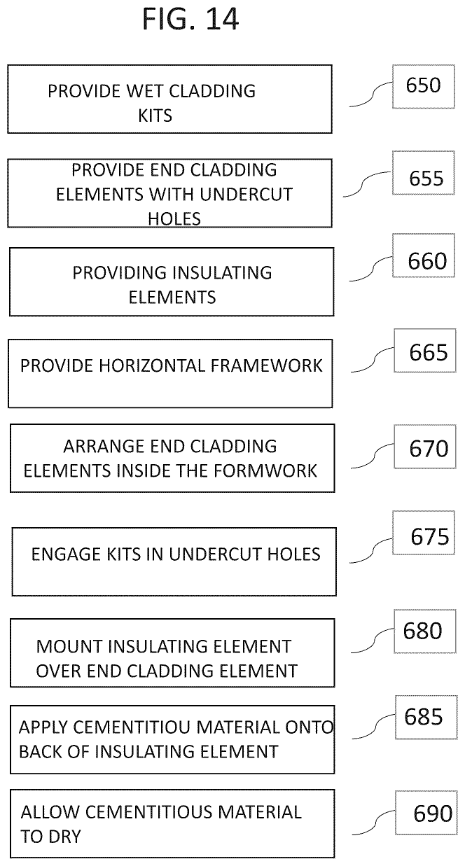

FIG. 14 is a simplified flow chart of the above described method for wet cladding and insulating a wall in accordance with some exemplary embodiments. According to some exemplary embodiments, the method includes providing a plurality of wet cladding kits (block 650), end cladding elements with holes (e.g., undercut holes) (block 655) and insulating elements (block 660) at a construction site. According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled or non-assembled system may then be used to construct an insulated, wet-cladded wall of a structure. The front surface of the end cladding elements are arranged in an area defined by a framework (block 670). According to some exemplary embodiments, framework contains a horizontal surface and the end cladding elements are spaced with spacers which are placed thereon.

In some exemplary embodiments, water sealing strips are applied onto back surfaces of the end cladding elements to cover gaps between the end cladding elements. The sealing strips may seal the gaps and prevent leakage of the cementitious material onto the front surface of the end cladding elements and the outer sheet of the formwork. According to some exemplary embodiments, the securing plates are positioned over the sealing strips.

According to exemplary embodiments, the kits may then be engaged in the holes (e.g., undercut holes) (block 675).

The insulating element may be mounted over the end cladding element (block 680) such that the cementitious material engaging elements of the kit extend through the plurality of insulating element, and further such that a back surface of the end cladding element and a front surface of the insulating element form intimate contact there between, as described herein above.

Reinforcements may be added to the defined volume, e.g., reinforcement bars or metal mesh. According to some exemplary embodiments, the engaging elements penetrate holes of the reinforcement metal mesh and engage with the reinforcement metal mesh.

According to some exemplary embodiments, the cementitious material is added to the defined volume (block 685) of the horizontal framework and allowed to dry (block 690). In some exemplary embodiments, the cementitious material is added with a pump pumping the cementitious material. In some exemplary embodiments, the cementitious material is added through a funnel to reduce the flow rate of the cementitious material within the volume. According to some exemplary embodiments, the cementitious material is added directly on the back surfaces of the insulating element.

After drying of the cementitious material, the framework may be removed. According to some exemplary embodiments, the method includes removing cementitious material leakages from a front surface of said plurality of end cladding elements.

According to another aspect of the invention, a method is provided for constructing a cladded wall. The method comprises:
(a) providing a plurality of wet cladding kits, each of said kits comprising:
   (i) an undercut anchor configured for being inserted into a hole (e.g., an undercut hole) formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with said proximal end of said cementitious material engaging element, said flaring element configured for flaring said undercut anchor in said hole (e.g., undercut hole);
(b) providing a plurality of end cladding elements formed with holes (e.g., undercut holes) in back surfaces thereof;
(c) providing a plurality of insulating elements;
(d) applying cementitious material into a horizontal framework;
(e) engaging said cementitious material engaging element in said holes (e.g., undercut holes);
(f) mounting said plurality of insulating elements over said end cladding elements so as to generate insulated end cladding elements, such that cementitious material engaging elements of said kit extend through said plurality of insulating elements, and further such that a back surface of said end cladding element and a front surface of said insulating element form intimate contact therebetween;
(g) placing said insulated end cladding elements with a back surface thereof onto said cementitious material; and
(h) allowing said cementitious material to harden with said cementitious material engaging elements penetrating therein, thereby constructing the cladded wall.

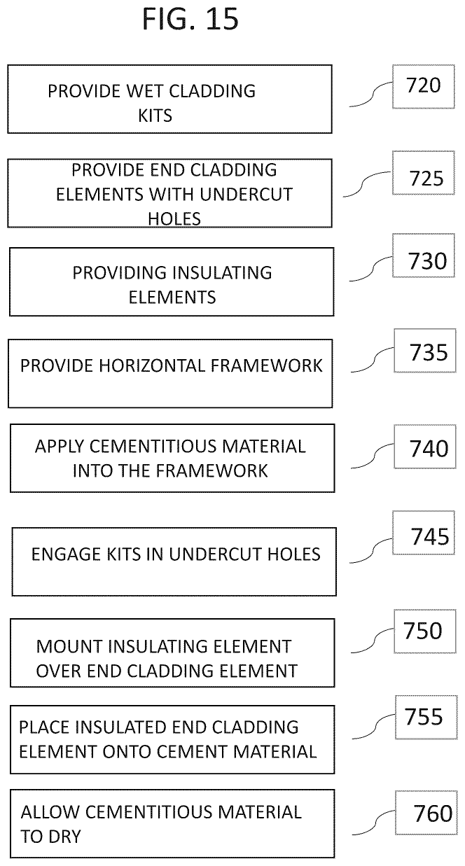

FIG. 15 is a simplified flow chart of the above described method for wet cladding and insulating a wall in accordance with some exemplary embodiments. According to some exemplary embodiments, the method includes providing a plurality of wet cladding kits (block 720), end cladding elements with holes (e.g., undercut holes) (block 725) and insulating elements (block 730) at a construction site. According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled or non-assembled system may then be used to construct an insulated, wet-cladded wall of a structure. The method further includes providing a horizontal framework (block 735) and pouring cement into the space defined by the framework (block 740).

According to exemplary embodiments, the kits may then be engaged in the holes (e.g., undercut holes) (block 745).

The insulating element may be mounted over the end cladding element (block 750) such that the cementitious material engaging elements of the kit extend through the plurality of insulating element, and further such that a back surface of the end cladding element and a front surface of the insulating element form intimate contact there between, as described herein above.

The insulated end cladding element is then placed on the wet cement (block 755), after which the cement is left to dry (block 760).

Reinforcements may be added to the defined volume of cementitious material, e.g., reinforcement bars or metal mesh. According to some exemplary embodiments, the engaging elements penetrate holes of the reinforcement metal mesh and engage with the reinforcement metal mesh.

According to another aspect of the invention, a method is provided a method of cladding a backup wall. The method comprises:
(a) providing a plurality of wet cladding kits, each of said kits comprising:
   (i) an undercut anchor configured for being inserted into a hole (e.g., an undercut hole) formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with, said proximal end of said cementitious material engaging element, said flaring element configured for flaring said undercut anchor in said hole (e.g., undercut hole);
(b) providing a plurality of end cladding elements formed with holes (e.g., undercut holes) in back surfaces thereof;
(c) providing a plurality of insulating elements;
(d) engaging a reinforcement metal mesh onto a backup wall to be cladded;
(e) engaging said kits in said holes (e.g., undercut holes);
(f) mounting said plurality of insulating elements over said end cladding elements, such that cementitious material engaging elements of said kit extend through said plurality of insulating elements, and further such that a back surface of said end cladding element and a front surface of said insulating element form intimate contact there between;
(g) applying said cementitious material between said back surfaces of said plurality of insulating elements and said backup wall with said cementitious material engaging elements penetrating into the cementitious material; and
(h) allowing said cementitious material to harden with said cementitious material engaging elements penetrating therein, thereby wet cladding the backup wall.

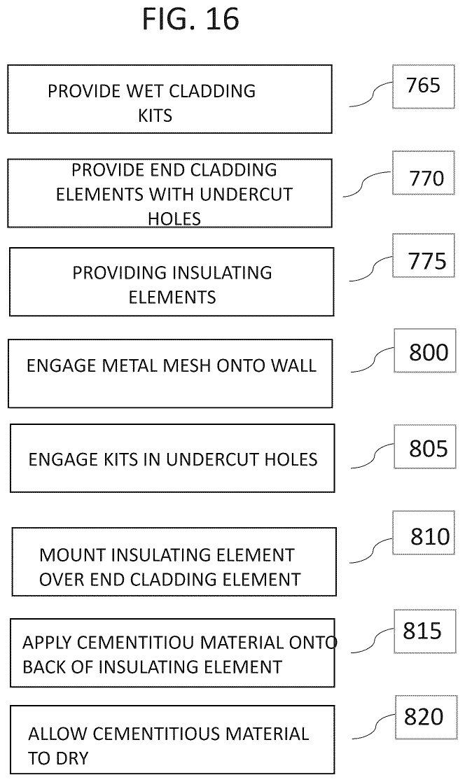

FIG. 16 is a simplified flow chart of the above described method for wet cladding and insulating a wall in accordance with some exemplary embodiments. According to some exemplary embodiments, the method includes providing a plurality of wet cladding kits (block 765), end cladding elements with holes (e.g., undercut holes) (block 770) and insulating elements (block 775) at a construction site. According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled or non-assembled system may then be used to construct an insulated, wet-cladded wall of a structure. The method further includes engaging a metal mesh onto a wall (block 800).

According to exemplary embodiments, the kits may then be engaged in the holes (e.g., undercut holes) (block 805).

The insulating element may be mounted over the end cladding element (block 810) such that the cementitious material engaging elements of the kit extend through the plurality of insulating element, and further such that a back surface of the end cladding element and a front surface of the insulating element form intimate contact there between, as described herein above.

Cementitious material is applied to the back of the insulating element or the back up wall (block 815) and the insulated end cladding elements are placed on the wall with the cementitious material engaging elements penetrating into the cementitious material and between the metal mesh.

The cementitious material is then allowed to dry (block 820).

According to another aspect of the invention, a method is provided a method of cladding a backup wall. The method comprises:
(a) providing a plurality of wet cladding kits, each of said kits comprising;
   (i) an undercut anchor configured for being inserted into a hole (e.g., an undercut hole) formed on a back surface of an end cladding element;
   (ii) a cementitious material engaging element which comprises a distal end for embedding into said cementitious material and a proximal end;
   (iii) a flaring element being firmly connected to, via a distal end thereof, or being integrally formed with, said proximal end of said cementitious material engaging element, said flaring element configured for flaring said undercut anchor in said hole (e.g., undercut hole);
(b) providing a plurality of end cladding elements formed with holes (e.g., undercut holes) in back surfaces thereof;
(c) providing a plurality of insulating elements;
(d) providing a formwork having an outer sheet and an inner sheet;
(e) arranging said plurality of end cladding elements with a front surface thereof against a back surface of said outer sheet of said formwork;
(e) engaging said cementitious material engaging element in said holes (e.g., undercut holes);
(f) mounting said plurality of insulating elements over said end cladding elements such that said cementitious material engaging element extends through said plurality of insulating elements, wherein a back surface of said end cladding element is positioned in intimate contact with a front surface of said insulating element;
(g) securing said plurality of end cladding elements to said outer sheet of each said formwork so as to form a plurality of assemblages;
(h) hoisting said plurality of assemblages to a floor under construction and placing said plurality of assemblages adjacent to one another;
(i) placing a plurality of reinforcing elements against said back surface of said plurality of end cladding elements;
(j) connecting each said inner sheet and each respective said outer sheet of said plurality of formworks to one another with formwork connecting elements, so as to form a continuous formwork unit;
(k) applying said cementitious material into said continuous formwork unit; and
(l) allowing said cementitious material to harden with said cementitious material engaging element penetrating therein, thereby constructing a cladded wall.

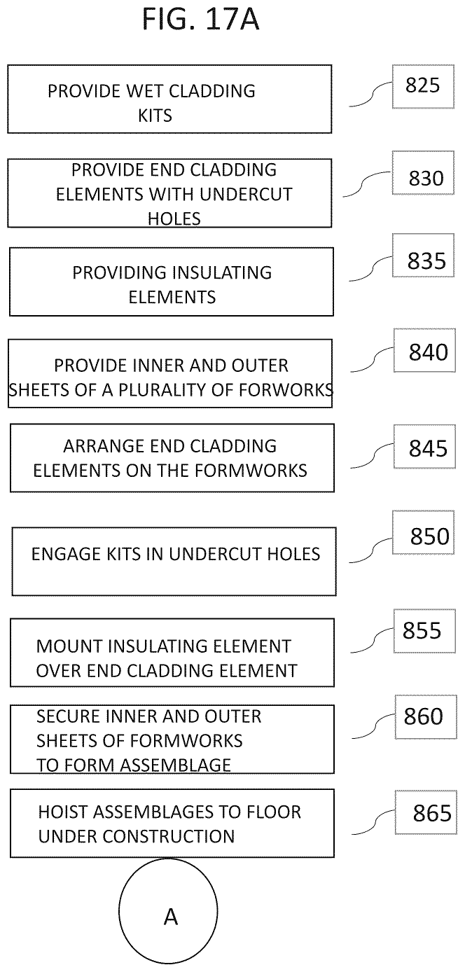

FIG. 17A-B is a simplified flow chart of the above described method for wet cladding and insulating a wall in accordance with some exemplary embodiments. According to some exemplary embodiments, the method includes providing a plurality of wet cladding kits (block 825), end cladding elements with holes (e.g., undercut holes) (block 830) and insulating elements (block 835) at a construction site. According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled or non-assembled system may then be used to construct an insulated, wet-cladded wall of a structure.

The front surface of the end cladding elements are arranged on the back surface of the outer sheet of the formwork (block 845). According to some exemplary embodiments, the end cladding elements are spaced with spacers.

According to some exemplary embodiments, the end cladding elements are secured against the outer sheet of said formwork with securing plates. According to some exemplary embodiments, the securing plates are secured to the outer sheet of said formwork through the spacers. According to some exemplary embodiments each of the securing plates are arranged on the back surface of the end cladding elements (over the joining edge of two adjacent end cladding elements with spacers therebetween). According to some exemplary embodiments, the spacers are fixed to the outer sheet of the formwork with a screw thread connection. In some exemplary embodiments, water sealing strips are applied onto back surfaces of the end cladding elements to cover gaps between the end cladding elements. The sealing strips may seal the gaps and prevent leakage of the cementitious material onto the front surface of the end cladding elements and the outer sheet of the formwork. According to some exemplary embodiments, the securing plates are positioned over the sealing strips.

According to exemplary embodiments, the kits may then be engaged in the holes (e.g., undercut holes) (block 850).

The insulating element may be mounted over the end cladding element (block 855) such that the cementitious material engaging elements of the kit extend through the plurality of insulating element, and further such that a back surface of the end cladding element and a front surface of the insulating element form intimate contact there between, as described herein above.

The front portion and the back portion of the formwork may then be secured to one another to define a volume in which the cementitious material may be received (block 860) to form an assemblage.

If not already at the site of construction, the assemblages are then hoisted to a floor under construction and placed adjacent to one another to form a continuous structure of assemblages (block 865).

In some exemplary embodiments, a reinforcement metal mesh is placed between the end cladding elements and the inner sheet of the formwork—block 870.

The front portion and the back portion of the formwork may then be secured to one another to define a volume in which the cementitious material may be received and form a unit (block 875). A continuous framework unit is thus constructed. Cementitious material is added into the continuous framework unit (block 880) and allowed to dry (block 885). In some exemplary embodiments, the cementitious material is added with a pump which pumps the cementitious material. In some exemplary embodiments, the cementitious material is added through a funnel to reduce the flow rate of the cementitious material within the volume.

Table 2 below combines some optional engineering values, rendering the wet cladding kits, methods, systems and/or constructions of some exemplary embodiments superior over any prior art wet cladding method. It is to be understood that any optional value or any combination of any one or more optional alternative values can be used in conjunction of the wet cladding kits, methods, systems and/or constructions described herein, even if a given combination of any one or more optional alternative values is not explicitly described.

TABLE 2

| Item | Specification |
|---|---|
| Material | e.g., Ceramic Porcelain, other |
| Size | X: at least 35 cm; |
| | Y: at least 35 cm; |
| | Alternatively and optionally |
| | 30 × 60 − 60 × 120 cm². |
| Inherent water | Less than 0.5% w/w when soaked |
| absorption | in water. E.g., less than 0.1% w/w. |
| | Optionally, 0% w/w. |
| | Substantially o water absorption |
| | from the front surface of the |
| | cladding element. |
| Abrasion Resistance | Class, 1 or better, Class 2 or better, |
| | class 3 or better, Class 4 or better, |
| | According to Israeli Building |
| | Standard 314. |
| Tile Thickness | 9-12 mm, optionally about 10 mm. |
| Tile Breaking Strength | Over 1300 Newton, optionally over |
| | 1600 Newton, optionally over 2000 |
| | Newton |
| Tile Bending Strength | 32 Newton/mm², optionally 35 |
| | Newton/mm² |
| Tile Breaking strength | At least 1300 Newton, optionally at |
| | least 1550 Newton, optionally at |
| | least 1,800 Newton |

Mechanical Fixing of the Kit to the end cladding element

| | |
|---|---|
| Kit pull strength | Over 10 Kg pull strength, |
| | optionally over 20 Kg pull strength, |
| | optionally over 40 Kg pull strength |
| | optionally about 10 Kg pull strength. |
| Pin thickness (per kit) | At least 3 mm, optionally at least |
| | about 4 mm. |
| Pin Material | Stainless steel (Nirosta), optionally |
| | stainless steel 316, optionally |
| | stainless steel 304 |
| Load Dispersion | At least 20 mm in diameter, |
| Element (per kit) | optionally at least 30 mm in |
| | diameter, optionally at least 40 mm |
| | in diameter, optionally at least 50 |
| | mm in diameter. If not circular, |
| | diameter refers to the longest |
| | diameter of an inclusion circle. |
| | Optionally 0.5-2 mm in thickness, |
| | optionally about 1 mm in thickness. |
| Pin Length (per kit), | 50-90 mm, optionally 50-80. |
| protrusion into | |
| cement/concrete | |
| Undercut Hole Diameter | 5-9 mm, optionally about 6 mm. |
| at surface | |
| Undercut Hole Depth | 5-7 mm, optionally about 6 mm. |
| Cladding element | At least 100 Kg/m², optionally at |
| pulling strength | least 500 Kg/m², optionally at least |
| | 1000 Kg/m², optionally at least |
| | 1500 Kg/m², optionally at least |
| | 2000 Kg/m², optionally at least |
| | 2300 Kg/m². |
| Kits per square meter | At least 11, at least 12; at least |
| of cladding element | 13-20. |
| Kits per Kg of | At least 11/35 Kg, at least 12/35 |
| cladding element | Kg; at least 13-20/35K. |

The present inventors have now devised a method for attaching an undercut anchor to the back surface of an end-cladding element without the need to drill an undercut hole, provided the material of the end-cladding element is sufficiently non-brittle and plastic.

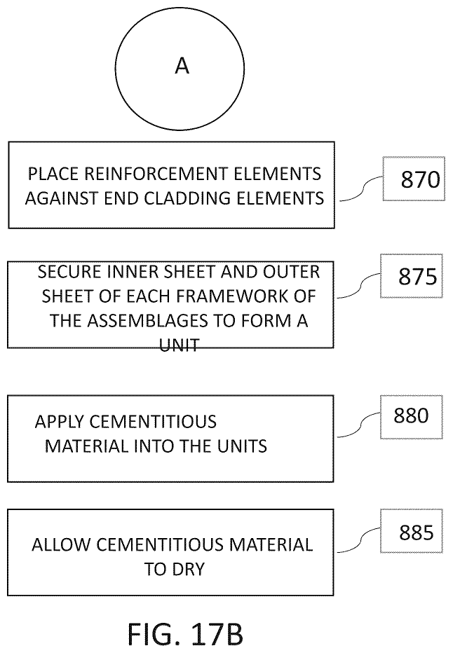

FIGS. 18A-C illustrate how an undercut anchor may be attached to an end-cladding element without the need to drill undercut holes.

FIG. 18A depicts a round, blind hole 110 having an opening on a back surface 101 of an end-cladding element 100. Blind hole 110 is defined by internal walls having a length and a substantially identical diameter along the length. Blind hole 110 does not penetrate the front surface 102 of the end-cladding element 100.

FIG. 18B depicts an unflared undercut anchor 220 partially inserted into a blind hole 110.

FIG. 18C depicts a flared undercut anchor 220 which has now been fully inserted into blind hole 110, following the screwing of a flaring element 260 into undercut anchor 220. The screwing allows undercut anchor 220 to flare inside hole 110 beyond the internal walls of the hole. As the anchor flares, it compresses material of the end-cladding element defining the hole. Thus, the material 270 of the end-cladding element surrounding undercut anchor 220 is more compressed than the material of the end-cladding element not surrounding the undercut anchor. Without being bound to theory, it is believed that the compression of the material around the undercut anchor leads to the enhanced retention force exerted by the end-cladding element on the undercut anchor.

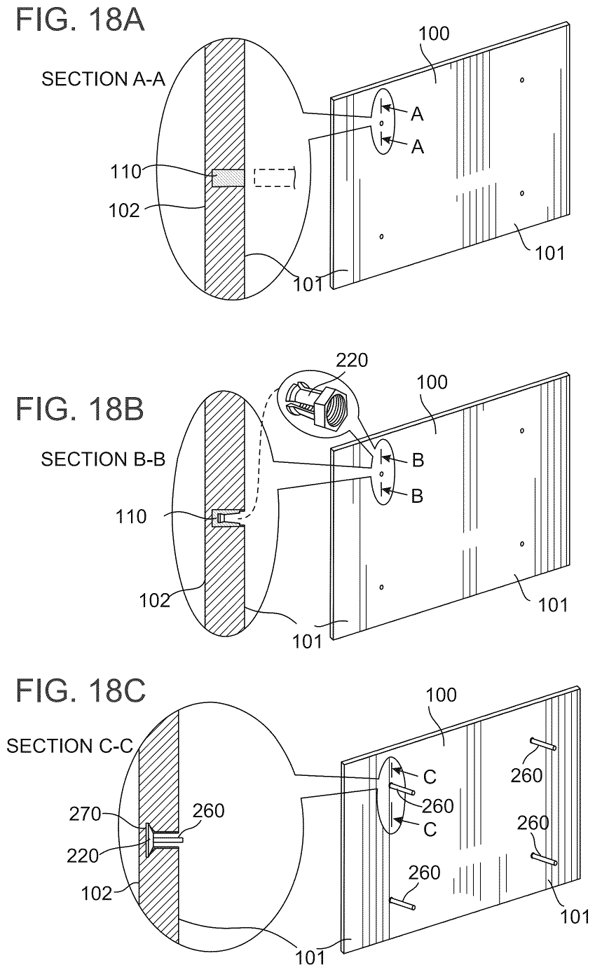

For the sake of comparison, reference is now made to FIGS. 19A-19C which depicts various stages of securing an undercut anchor in an undercut hole which traverses a thickness of an end-cladding element, according to currently known methods.

FIG. 19A depicts undercut hole 105 on a back surface 101 of end-cladding element 100.

FIG. 19B depicts a non-flared undercut anchor 220 partially inserted into undercut hole 105.

FIG. 19C depicts flared undercut anchor 220 which has now been fully inserted into undercut hole 105, following the screwing of flaring element 260 into undercut anchor 220. The screwing allows the undercut anchor to flare inside the hole.

The present method for securing an undercut anchor into an end-cladding element portrayed in FIGS. 18A-C may be summarized as follows:

A method of securing an undercut anchor in a blind hole which traverses a thickness of an end-cladding element, the blind hole having an opening on a back surface of the end-cladding element, the blind hole being defined by internal walls having a length and a substantially identical diameter along said length, the method comprises inserting the undercut anchor into the blind hole; and screwing a flaring element into the undercut anchor, so as to allow the undercut anchor to flare inside the hole and beyond the internal walls of the hole, while compressing material of the end-cladding element surrounding the hole.

According to some exemplary embodiments, the end-cladding elements may be pre-formed with the uniform holes, e.g., during manufacturing or may be drilled following manufacturing. In an exemplary embodiment, the hole is about 5-7 mm in diameter and about 4-7 mm in depth. According to exemplary embodiments, the end-cladding element is formed with a plurality of holes, e.g., 4-8, 4-12 or 4-50 holes.

Typically, each end-cladding element comprises a plurality of holes—for example at least four, one in each corner, at least 6, at least 8, at least 12. Depending on the size of the end-cladding element more holes may be drilled.

Thus, the present invention provides for an end-cladding element having a back surface which comprises a blind hole into which an undercut anchor has been flared and secured, the end-cladding element being fabricated from a material, wherein the material of the end-cladding element surrounding the undercut anchor, after the undercut anchor has been flared and secured, is more compressed than the material of the end-cladding element not surrounding the undercut anchor.

The end-cladding elements which can be used in the present invention have a wide range of thicknesses less than 3 cm, e.g., 1 cm-3 cm, less than 2 cm, e.g., 1.9 cm, or 1.5 cm or less, or even 9-12 mm. The end-cladding elements may be of any shape (e.g., a polygon, such as rectangular or square; or combination of polygons having, for example, 5 and 6 gons to clad curved surfaces; or a non-polygon) and of any size—e.g., between 20 cm-5 meters in length and between 20 cm to 5 meters in height. According to some exemplary embodiments at least one of the plurality of cladding elements is a quadrangle having X and Y dimensions, whereby both X and Y are each independently greater than 35 cm. The back surface of the end-cladding element may be smooth or rough.

The end-cladding element is fabricated from a material having a plasticity and being sufficiently non-brittle, so as to allow flaring of the undercut anchor into the material without breaking the end-cladding element, the material having a retention force that allows rigid attachment of the undercut anchor to the end-cladding element.

According to a particular embodiment, the end-cladding element is fabricated from a cementitious material, including but not limited to pre-fabricated cement boards (e.g., cement bonded particle board or a cement fiber board).

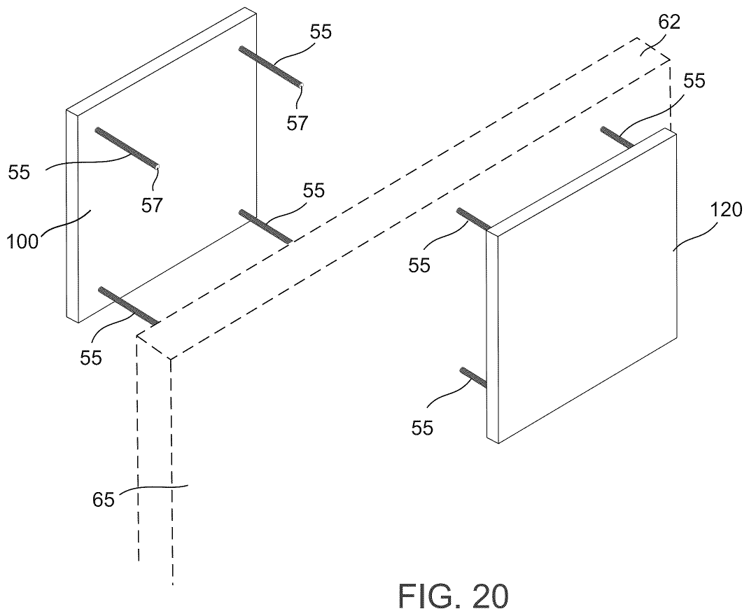

As mentioned herein above, the present invention also contemplates using U-shaped elements for connecting cementitious material engaging elements to end-cladding elements via holes (e.g. slots) in the sides of the end-cladding elements. The end-cladding elements must be sufficiently thick and non-brittle so as to allow drilling of side holes therein. This method will be further described with the aid of FIGS. 21A-D, 22A-C and 23A-B.

FIGS. 21A, 21B, 21C and 21D are respectively an alternate example system including an example kit with an example U-shaped element, two perspective views of the example kit and a sectional view of the example kit installed on an edge of an end cladding element, all in accordance with some example embodiments. According to some example embodiments, a system 400 includes an end cladding element 100 (or 120) and one or more end cladding kits 410. According to some example embodiments, kit 410 includes a U-shaped element 412 and a pin 414 (i.e., a cementitious material engaging element) extending out from U-shaped element 412. U-shaped element is formed with a first wall 416, a second wall 418 spaced from first wall 416 and a base 420 extending from first wall 416 to second wall 418. According to some example embodiments, pin 414 extends out from first wall 416 in a substantially normal direction. A distal end of pin 414 may include cement anchoring element 422. According to some example embodiments, second wall 418 is configured to be received within a slot formed through an edge surface of end cladding element 100.

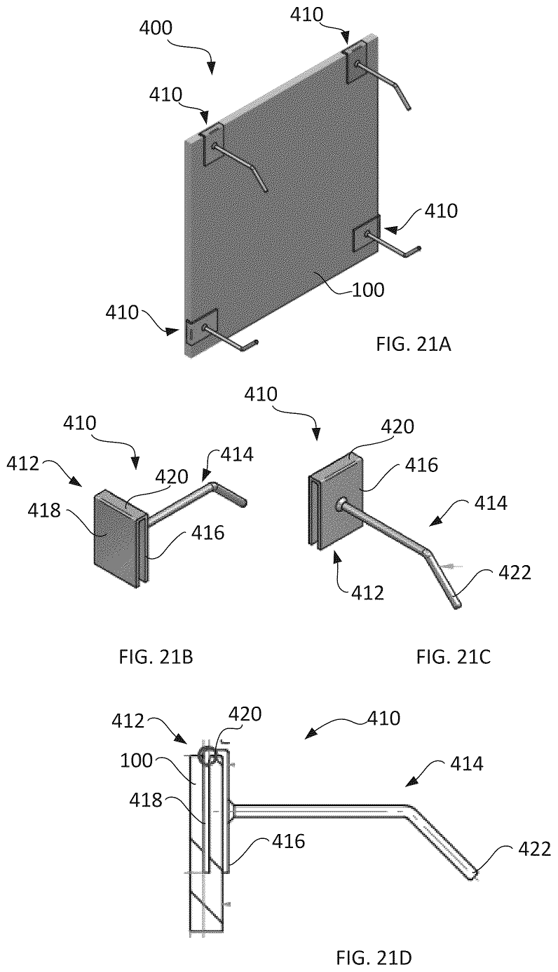

FIGS. 22A, 22B and 22C are two perspective views of another example kit with a U-shaped piece and a sectional view of the example kit installed on an edge of an end cladding element, all in accordance with some example embodiments. In some example embodiments, second wall 418 of U-shaped element 412 may be shorter than first wall 416 and/or otherwise shaped. Optionally, second wall 418 includes a curved shape to match a shape of a slot cut through an edge surface of end cladding element through which second wall 418 is to be received.

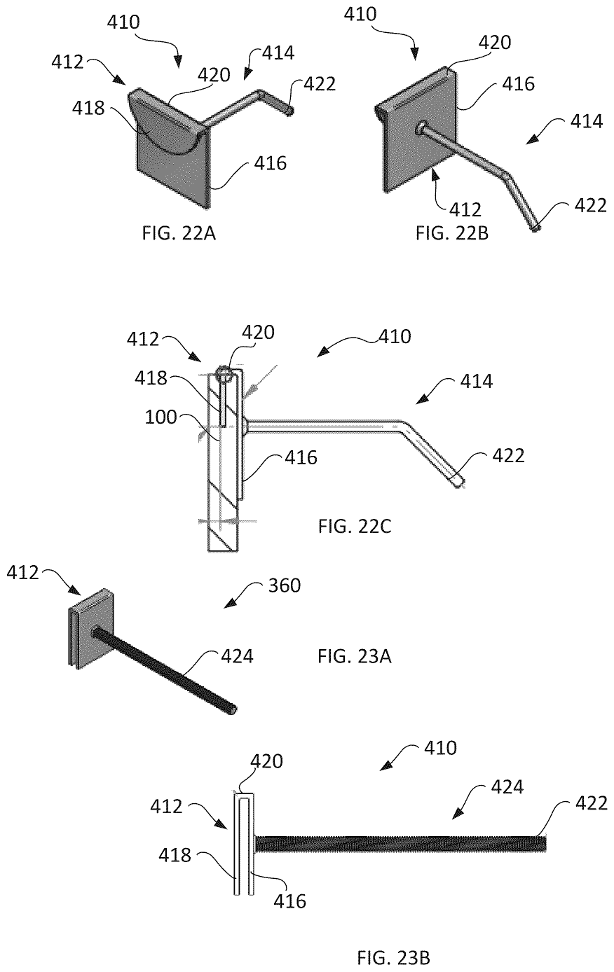

FIGS. 23A and 23B are respectively a perspective view and a side view of yet another example kit including a U-shaped piece in accordance with some example embodiments. In some example embodiments, kit 410 includes a stud pin 424 with screw threads that extend to cement anchoring element 422 at a distal end. In other example embodiments, the screw threads do not extend into cement anchoring element 422. Stud pin 424 may be fixed onto U-shaped element 412 based on welding or with a screw type connection.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, and mechanical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In addition, any priority document(s) of this application is/are hereby incorporated herein by reference in its/their entirety.

1. A wet cladding method for constructing a cladded wall, the method comprising:
(a) providing a plurality of wet cladding kits, each of said kits comprising:
(i) an undercut anchor configured for being inserted into a hole formed on a back surface of an end cladding element;
(ii) a cementitious material engaging element which comprises a distal end for embedding into said cementitious material and a proximal end;
(iii) a flaring element being firmly connected to, via a distal end thereof, or being integrally formed with, said proximal end of said cementitious material engaging element, said flaring element configured for flaring said undercut anchor in said hole;
(b) providing a plurality of end cladding elements formed with holes in back surfaces thereof;
(c) providing a plurality of insulating elements;
(d) providing a formwork having an outer sheet and an inner sheet;
(e) arranging said plurality of end cladding elements with a front surface thereof against a back surface of said outer sheet of said formwork;
(f) engaging said kits in said holes;
(g) mounting said plurality of insulating elements over said end cladding elements, such that cementitious material engaging elements of said kit extend through said plurality of insulating elements, and further such that a back surface of said end cladding elements and a front surface of said insulating elements form intimate contact there between;
(h) securing said outer sheet of said formwork to said inner sheet of said formwork with a formwork connecting element;
(i) applying said cementitious material between said inner sheet and said outer sheet of said formwork;
(j) allowing said cementitious material to harden with said cementitious material engaging elements penetrating therein, thereby constructing the cladded wall.

2-4. (canceled)

5. A wet cladding method for constructing a cladded wall, the method comprising:
(a) providing a plurality of wet cladding kits, each of said kits comprising;
(i) an undercut anchor configured for being inserted into an hole formed on a back surface of an end cladding element;
(ii) a cementitious material engaging element which comprises a distal end for embedding into said cementitious material and a proximal end;
(iii) a flaring element being firmly connected to, via a distal end thereof, or being integrally formed with, said proximal end of said cementitious material engaging element, said flaring element configured for flaring said undercut anchor in said hole;
(b) providing a plurality of end cladding elements formed with holes in back surfaces thereof;
(c) providing a plurality of insulating elements;
(d) providing a formwork having an outer sheet and an inner sheet;
(e) arranging said plurality of end cladding elements with a front surface thereof against a back surface of said outer sheet of said formwork;
(e) engaging said cementitious material engaging element in said holes;
(f) mounting said plurality of insulating elements over said end cladding elements such that said cementitious material engaging element extends through said plurality of insulating elements, wherein a back surface of said end cladding element is positioned in intimate contact with a front surface of said insulating element;
(g) securing said plurality of end cladding elements to said outer sheet of each said formwork so as to form a plurality of assemblages;
(h) hoisting said plurality of assemblages to a floor under construction and placing said plurality of assemblages adjacent to one another;
(i) placing a plurality of reinforcing elements against said back surface of said plurality of end cladding elements;
(j) connecting each said inner sheet and each respective said outer sheet of said each said formwork to one another with formwork connecting elements, so as to form a continuous formwork unit;
(k) applying said cementitious material into said continuous formwork unit; and
(l) allowing said cementitious material to harden with said cementitious material engaging element penetrating therein, thereby constructing a cladded wall.

6-10. (canceled)

11. The method of claim 1, wherein said wet cladding kits further comprise a load dispersion element connectable to, or integrally formed with, said flaring element or said undercut anchor, wherein said load dispersion element is configured to disperse load over a surface area of said load dispersion element, wherein said surface area is at least twice the surface area of said hole, so as to reduce load imposed by said undercut anchor on walls defining said hole.

12. The method of claim 11, wherein said load dispersion element is positioned between said back surface of said end cladding element and said front surface of said insulating elements.

13. The method of claim 1, wherein said insulating elements are thermal insulating elements and/or acoustic insulating elements.

14. The method of claim 1, further comprising fastening said insulating elements to said end cladding elements with a fastening piece.

15. The method of claim 14, wherein said fastening piece comprises:
a plate section;
a bore extending through said plate section for receiving said cementitious material engaging element; and
at least one prong extending out from said plate section;
wherein said fastening piece is configured to be fixed in the cementitious material when the cementitious material hardens and to engage said insulating element positioned on said back surface of the end cladding element.

16. The method of claim 1, further comprising temporarily securing said end cladding element to an outer surface of said formwork with a securing plate and a removable end cladding element securing agent following said arranging and prior to said applying.

17-18. (canceled)

19. The method of claim 1, further comprising attaching water sealing strips to said back surface of adjacent end cladding elements prior to said applying.

20-21. (canceled)

22. The method of claim 1, wherein said arranging comprises spacing said plurality of end cladding elements with spacers spaced on said back surface of said outer sheet of said formwork, wherein said spacers are integral to or permanently attached to said formwork.

23. The method of claim 1, further comprising placing a reinforcement metal mesh or bars between said plurality of end cladding elements and said inner sheet of said formwork.

24-25. (canceled)

26. The method of claim 1, further comprising:
(k) arranging an additional set of end-cladding elements with a front surface thereof against a back surface of an inner sheet of said formwork; and
(l) connecting cementitious material engaging elements with said end-cladding elements of said additional set, wherein steps (k) and (l) are carried out prior to step (h).

27-28. (canceled)

29. The method of claim 26, wherein said additional set of end-cladding elements comprise pre-fabricated cement boards.

30. (canceled)

31. The method of claim 26, wherein said connecting is via holes that are formed in back surfaces of said additional set of end-cladding elements into which undercut anchors have been inserted, wherein said holes are undercut holes or are defined by internal walls having a length and a substantially identical diameter along said length.

32-34. (canceled)

35. The method of claim 26, further comprising mounting, prior to step (h), a layer being of a material that is softer than said end-cladding element, over said end-cladding elements of said additional set, such that said cementitious material engaging element traverses and extends beyond a thickness of said layer, and further such that a back surface of said end-cladding element of said additional set and a front surface of said layer form intimate contact therebetween.

36-39. (canceled)

40. The method of claim 35, wherein said material of said layer is polystyrene or Styrofoam.

41. A structure constructed using the methods of claim 1.

42. A cladded structure comprising:
(a) a plurality of cementitious material engaging elements;
(b) a plurality of end cladding elements having a front surface and a back surface, wherein said back surface comprises at least one hole;
(c) a plurality of insulation elements having a front surface and a back surface, mounted on said back surface of said plurality of end cladding elements such that a front surface of said insulation elements are in intimate contact with said back surface of said end cladding elements; and
(d) hardened cementitious material;
wherein said plurality of cementitious material engaging elements are engaged in said hardened cementitious material via said hole, thereby providing mechanical fixing of the insulated end cladding elements to said hardened cementitious material.

43-63. (canceled)

64. The method of claim 1, wherein at least eleven kits are provided per 35 kg of end cladding element.

65. The method of claim 1, wherein a pulling strength of said cladding element is at least 100 Kg/m².

66-71. (canceled)
